(19) United States
(12) Patent Application Publication
(10) Pub. No.: US 2026/0339998 A1
(43) Pub. Date: Oct. 29, 2026

(54) ARTIFICIAL INTELLIGENCE-BASED SYSTEM AND METHOD FOR RESOLVING WORK ITEMS IN SERVICE MANAGEMENT PLATFORMS

(71) Applicant: Kahuna Labs, Inc., San Jose, CA (US)

(72) Inventors: Gurmeet Singh Manku, San Jose, CA (US); Sanjeev Gupta, San Jose, CA (US); B Chaitanya Potluri, San Jose, CA (US); Shanu Vashishtha, Livingston, NJ (US); Hitesh Sharma, San Jose, CA (US); Sudhamsh Goutham Teegala, Dublin, CA (US)

(21) Appl. No.: 19/656,334

(22) Filed: Apr. 23, 2026

Related U.S. Application Data
(60) Provisional application No. 63/793,698, filed on Apr. 24, 2025.

(51) Int. Cl. G06F 16/3329; G06F 16/21; G06F 16/28

(52) U.S. Cl. CPC G06F 16/33295; G06F 16/211; G06F 16/285

(57) ABSTRACT

An AI-based system and method for resolving work items in service management platforms, are disclosed. The AI-based method comprises creating the work items based on work item data obtained from first users, using language models. The process is followed by generating queries for the first users for receiving responses comprising missing details associated with work items from the first users to comprehensively analyze issue associated with the work items. The process further includes generating recommendations based on the work item data, the received responses associated with queries, and historical work items, using ML models. The process further includes updating the work items based on the recommendations. The process further includes generating troubleshooting responses based on an analysis of the updated work items, knowledge base documents, and historical resolutions, using the ML models, to resolve the work items.

### CROSS-REFERENCE TO RELATED APPLICATIONS

This application claims priority from provisional U.S. Application No. 63/793,698 titled ARTIFICIAL INTELLIGENCE-BASED SYSTEM AND METHOD FOR RESOLVING WORK ITEMS INSERVICE MANAGEMENT PLATFORMS, filed on Apr. 24, 2025, which is hereby incorporated by reference in its entirety

### TECHNICAL FIELD

Embodiments of the present disclosure relate to artificial intelligence-based systems for customer support, and more specifically an artificial intelligence-based system and an artificial intelligence-based method for resolving one or more work items in service management platforms.

### BACKGROUND

In technical product support, enterprise product support, user support and Information Technology (IT) service management, efficient work item resolution is valuable for maintaining user satisfaction and operational continuity. Support teams rely on historical records, internal documentation, and expert knowledge to diagnose and resolve issues. However, this process is extremely fragmented, requiring the support teams to search across multiple platforms, such as service management platforms, engineering documentation, and communication tools. A manual nature of this approach leads to inefficiencies, increased response times, and inconsistencies in troubleshooting.

Various existing solutions have attempted to streamline the work item resolution by implementing knowledge bases, rule-based automation systems, and Artificial Intelligence (AI)-powered chatbots. The knowledge bases provide structured information, but the knowledge bases require frequent manual updates and may not fully capture evolving troubleshooting strategies. The rule-based automation systems follow predefined workflows but have limitations in adapting to complex issues. The AI-powered chatbots assist in handling repetitive one or more queries but face challenges in understanding the nuances of technical troubleshooting. These limitations hinder the support teams from effectively leveraging past resolutions and expert insights in an automated manner.

Therefore, there is a need for an improved artificial intelligence (AI)-based system and method that may intelligently extract one or more troubleshooting steps from one or more historical work items, internal documentation, and expert discussions while automatically composing relevant one or more troubleshooting responses. Such an AI-based system should potentially drive down time required for the work item resolution and minimize the reliance on multiple information sources.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an artificial intelligence (AI)-based method for resolving one or more work items in service management platforms is disclosed. The AI-based method comprises obtaining, by one or more hardware processors, work item data from one or more communication devices associated with one or more first users. The AI-based method further comprises creating, by the one or more hardware processors, the one or more work items based on the work item data obtained from the one or more first users, using one or more language models. The AI-based method further comprises generating, by the one or more hardware processors, one or more queries for the one or more first users for receiving one or more responses comprising one or more missing details associated with the one or more work items from the one or more first users to comprehensively analyze an issue associated with the one or more work items.

The AI-based method further comprises generating, by the one or more hardware processors, one or more recommendations based on at least one of: the work item data, the received one or more responses associated with the one or more queries, and one or more historical work items, using one or more machine learning models. The one or more recommendations comprise at least one of: one or more message updates and one or more metadata field updates. The AI-based method further comprises updating, by the one or more hardware processors, the one or more work items based on the one or more recommendations. Updating the one or more work items comprises at least one of: adding a new message to the one or more work items, and updating one or more metadata fields associated with the one or more work items.

The AI-based method further comprises generating, by the one or more hardware processors, one or more troubleshooting responses based on an analysis of at least one of: the updated one or more work items, knowledge base documents, and historical resolutions, using the one or more machine learning models, to resolve the one or more work items. The one or more troubleshooting responses comprise at least one of: one or more troubleshooting steps and the one or more queries for the one or more first users to determine missing information that assist in generating accurate one or more troubleshooting steps.

In an embodiment, creating the one or more work items based on the work item data, using the one or more language models, comprises: (a) recognizing, by the one or more hardware processors, one or more work item descriptions from the work item data obtained from the one or more first users through at least one of: manual entry, an electronic mail, a text communication, an audio communication, a video communication, and an application programming interface, using the one or more language models; (b) extracting, by the one or more hardware processors, relevant data from the work item data based on the recognized one or more work item descriptions; and (c) creating, by the one or more hardware processors, the one or more work items being structured based on the extracted relevant data, wherein the structured one or more work items include at least one of: subject and description fields, along with the one or more metadata fields.

The subject and description fields comprise product information comprising at least one of: product name, version number, and configuration, optional documents comprising at least one of: Portable Document Formats (PDFs), screenshots, audio transcripts, spreadsheets, data dumps, files, images, and equivalent forms of digital content. The one or more metadata fields comprise creation time of the one or more work items, an identity of the one or more first users and associated environment, status information of the one or more work items, and priority and severity levels of the one or more work items.

In another embodiment, upon creating the one or more work items, the AI-based method further comprising processing the one or more work items, by: (a) augmenting, by the one or more hardware processors, the one or more work items with one or more attributes comprising at least one of: transcripts of video calls pertaining to an issue in the one or more work items, conversations in chat systems pertaining to the issue in the one or more work items, one or more documents related to the one or more work items, and one or more relevant work items; (b) augmenting, by the one or more hardware processors, the one or more work items with one or more additional attributes to record contextual metadata related to at least one of: product version, product configuration, user information, deployment environment related information, source configuration data, user relationship management systems, and product backend; (c) masking, by the one or more hardware processors, sensitive information including personally identifiable information by at least one of: substituting the sensitive information with one or more generic identifiers and redacting the sensitive information; (d) removing, by the one or more hardware processors, noisy and repetitive information from the one or more work items, using the one or more language models, wherein the noisy and repetitive information comprise at least one of: signatures in the electronic mail, parts of the electronic mail that quote previous electronic mails in an electronic mail thread, and electronic mails with operational steps; (e) computing, by the one or more hardware processors, a credibility score of the one or more work items, using at least one of: the one or more language models, one or more machine learning models, and one or more rule-based models, wherein the credibility score is a measure of trustworthiness of contents of the one or more work items derived from one or more signals comprising at least one of: first user confirmation indicating whether the issue was resolved, and frequency of references to at least one of: the knowledge base documents and the one or more troubleshooting steps across work items similar to the one or more work items, wherein the one or more signals are at least one of: each independent signal and a combination of the two or more signals; (f) computing, by the one or more hardware processors, a completeness score of the one or more work items, using at least one of: the one or more language models, one or more machine learning models, and one or more rule-based models, wherein the completeness score is a measure of completeness of troubleshooting path information available in the one or more work items derived from the one or more signals comprising at least one of: absence and presence of transcripts of video chats, absence and presence of descriptions of actual steps carried out by at least one of: the one or more first users and one or more second users, absence and presence of links to related work items and relevant knowledge base documents, and absence and presence of attachments comprising at least one of: logs, screenshots, errors, and stacktraces; (g) extracting, by the one or more hardware processors, at least one of: one or more contents of the one or more work items into a structured schema to identify one or more actions taken by at least one of: the one or more first users and the one or more second users, and questions and answers in the one or more work items, using the one or more language models; (h) creating, by the one or more hardware processors, ticket histories for the one or more work items to be stored as snapshots, using the one or more language models, wherein for each snapshot, one or more signals are computed comprising at least one of: presence and absence of video calls, product information, diagnostics collected, completeness score, the one or more troubleshooting steps, actions by at least one of: the one or more first users and the one or more second users, the questions and answers, error codes, error messages, alert names, and alert messages; and (i) clustering and indexing, by the one or more hardware processors, the snapshots for retrieving the one or more work items, using one or more clustering techniques.

The snapshots are clustered into one or more groups based on metrics comprising at least one of: semantic similarity between problem scenarios, semantic similarity between user configuration contexts, semantic similarity between the one or more troubleshooting steps, semantic similarity between the one or more actions by at least one of: the one or more first users and the one or more second users, semantic similarity between the questions and answers, and similarity of the product configuration. The snapshots are indexed using at least one of: probabilistic information retrieval ranking function and embeddings for retrieving the one or more snapshots based on the semantic similarity between the snapshots and the one or more work items.

In yet another embodiment, resolving the one or more work items based on the generated one or more troubleshooting responses, comprises: (a) computing, by the one or more hardware processors, a salutation by automatically deducing a name of the one or more first users by analyzing an initial work item from at least one of: subject, description, and metadata, using the one or more language models; (b) generating, by the one or more hardware processors, a work item summary for establishing a shared context between an AI-based system and the one or more first users, using the one or more language models, wherein the work item summary demonstrates that the AI-based system has correctly understood an intent of the one or more work items; (c) retrieving, by the one or more hardware processors, past snapshots and documents relevant to the one or more work items from the clusters and indexes, wherein the documents comprise at least one of: knowledge base articles, chat messages, and meeting transcripts; (d) extracting, by the one or more hardware processors, the one or more troubleshooting steps and the one or more queries from a combination of the past snapshots and the documents, wherein the troubleshooting steps and the one or more queries comprise at least one of: a verbatim copy of sentences from one or more sections of one or more knowledge base articles, a paraphrasing of the sentences, and content generated by the system; (e) computing, by the one or more hardware processors, metadata update recommendations from the relevant past snapshots and the documents by predicting updated values of the one or more metadata fields comprising the priority and severity levels, using the one or more language models; (f) computing, by the one or more hardware processors, status change recommendations from the relevant past snapshots and the documents by predicting a value for the status information comprising at least one of: open, first user confirmation pending, waiting for the one or more first users to answer questions, and resolved, using the one or more language models; (g) computing, by the one or more hardware processors, confidence scores for the troubleshooting steps and the one or more queries by combining at least one of: completeness scores, credibility scores, matching scores measuring strength of matches between the one or more work items and the past snapshots and the documents, and density scores measuring overlap between the troubleshooting steps in the relevant past snapshots and the documents, using the one or more language models; and (h) generating, by the one or more hardware processors, a closure comprising at least one of: instructions for escalation and instructions for reopening the one or more work items, using the one or more language models.

In yet another embodiment, generating the one or more troubleshooting responses, using the one or more machine learning models, comprises: (a) extracting, by the one or more hardware processors, one or more features comprising at least one of: issue descriptors, contextual parameters, and metadata, from the updated one or more work items; (b) retrieving, by the one or more hardware processors, the one or more historical work items and corresponding resolution data from one or more knowledge sources based on the extracted one or more features; (c) generating, by the one or more hardware processors, one or more similarity representations between the updated one or more work items and the one or more historical work items, using the one or more neural networks; (d) identifying, by the one or more hardware processors, one or more relevant historical work items and associated resolution patterns based on the one or more similarity representations; (e) determining, by the one or more hardware processors, one or more relationships between the updated one or more work items, the one or more historical work items, and the corresponding resolution data, using the one or more neural networks; and (f) generating, by the one or more hardware processors, the one or more troubleshooting steps for the one or more first users, based on the determined one or more relationships.

In yet another embodiment, the AI-method further comprising utilizing, by the one or more hardware processors, a knowledge graph for generating the one or more troubleshooting responses, by: (a) synthesizing, by the one or more hardware processors, the knowledge graph based on the work item data stored in one or more knowledge sources, wherein the knowledge graph is a graph structure with nodes and edges, wherein the nodes indicate one or more semantic concepts comprising at least one of: the one or more work items, one or more historical work items, the one or more troubleshooting steps, the knowledge base documents comprising internal and external knowledge base documents, and the one or more queries, and wherein the edges indicate one or more relationships between the nodes; (b) mapping, by the one or more hardware processors, one or more elements of the work item data to corresponding nodes in the knowledge graph; (c) traversing, by the one or more hardware processors, the knowledge graph to identify one or more related nodes corresponding to one or more relevant historical work items and associated resolution data; (d) extracting, by the one or more hardware processors, the one or more troubleshooting steps associated with the identified nodes based on the traversed knowledge graph; and (e) generating, by the one or more hardware processors, the one or more troubleshooting responses based on the extracted one or more troubleshooting steps.

In yet another embodiment, the AI-method further comprising at least one of: (a) maintaining, by the one or more hardware processors, the one or more work items as open until the one or more first users confirm a status of the issue associated with the one or more work items; (b) upon resolution of the one or more work items, updating, by the one or more hardware processors, the status of the one or more metadata fields to a pre-defined value comprising at least one of: closed and resolved, to indicate completion of a work item lifecycle, wherein the status update prevents application of subsequent message updates and metadata field updates to the one or more work items; and (c) continuing, by the one or more hardware processors, the status update of the one or more work items with further exchanges between the one or more first users and at least one of: the one or more second users and the AI-based system, when the issue associated with the one or more work items persists.

In yet another embodiment, the AI-method further comprising continuously optimizing, by the one or more hardware processors, troubleshooting accuracy by learning from expert corrections and work item resolutions, using one or more reinforcement leaning models.

In yet another embodiment, generating the one or more troubleshooting responses comprises utilizing a multi-agent architecture, by: (a) processing, by the one or more hardware processors, each snapshot associated with the one or more work items through a plurality of agents working in parallel, wherein each agent is configured to derive the one or more troubleshooting steps from a text corpus comprising at least one of: public knowledge base documents, private knowledge base documents for troubleshooting guides, private knowledge base documents for product guides, past cases, and product compatibility information; (b) generating, by the one or more hardware processors, an agent output by each agent, comprising: one or more predictions that comprise at least one of: the one or more troubleshooting steps, the one or more queries, and the one or more metadata field updates, reasoning that comprise an agent-specific textual description explaining why the one or more troubleshooting steps merit high confidence, and one or more confidence scores indicating how confident the agent is that the agent output contains the best one or more troubleshooting steps and the one or more queries; (c) receiving, by the one or more hardware processors, the agent outputs from the plurality of agents, using an agent mixer; (d) selecting, by the one or more hardware processors, top k agents based on the confidence scores associated with the agent outputs, using the agent mixer; and (e) combining, by the one or more hardware processors, the agent outputs from the selected top k agents into one or more coherent recommendations to generate a final agent output comprising the one or more troubleshooting responses, using the agent mixer.

In one aspect, an artificial intelligence (AI)-based system for resolving one or more work items in service management platforms, is disclosed. The AI-based system comprises one or more hardware processors and a memory unit. The memory unit is operatively coupled to the one or more hardware processors. The memory unit comprises a plurality of subsystems in form of machine-readable instructions executable by the one or more hardware processors. The plurality of subsystems comprises a data obtaining subsystem configured to obtain work item data from one or more communication devices associated with one or more first users.

The plurality of subsystems further comprises a work item creating subsystem configured to: (a) create the one or more work items based on the work item data obtained from the one or more first users, using one or more language models; and (b) generate one or more queries for the one or more first users for receiving one or more responses comprising one or more missing details associated with the one or more work items from the one or more first users to comprehensively analyze an issue associated with the one or more work items.

The plurality of subsystems further comprises a recommendations generating subsystem configured to: (a) generate one or more recommendations based on at least one of: the work item data and the received one or more responses associated with the one or more queries, using one or more machine learning models, wherein the one or more recommendations comprise at least one of: one or more message updates and one or more metadata field updates; and (b) update the one or more work items based on the one or more recommendations, wherein updating the one or more work items comprises at least one of: adding a new message to the one or more work items, and updating one or more metadata fields associated with the one or more work items.

The plurality of subsystems further comprises a troubleshoot response generating subsystem configured to generate one or more troubleshooting responses based on an analysis of at least one of: the updated one or more work items, knowledge base documents, and historical resolutions, using the one or more machine learning models, to resolve the one or more work items. The one or more troubleshooting responses comprise at least one of: one or more troubleshooting steps and the one or more queries for the one or more first users to determine missing information that assist in generating accurate one or more troubleshooting steps.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limited in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram representation of a network architecture depicting an artificial intelligence (AI)-based system for resolving one or more work items in service management platforms, in accordance with an embodiment of the present disclosure;

FIG. 2 is a detailed view of the AI-based system 102, such as those shown in FIG. 1, for resolving the one or more work items in the service management platforms, in accordance with an embodiment of the present disclosure;

FIG. 3 illustrates an exemplary flow diagram representation of resolving the one or more work items in the service management platforms, in accordance with an embodiment of the present disclosure;

FIG. 4 illustrates a multi-agent architecture with troubleshooting steps (TS) and probing questions (PQ) computation, in accordance with an embodiment of the present disclosure; and

FIG. 5 is a flow chart illustrating an AI-based method for resolving the one or more work items in the service management platforms, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a“ does not, without more constraints, preclude the existence of other devices, sub-systems, additional sub-modules. Appearances of the phrase ”in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

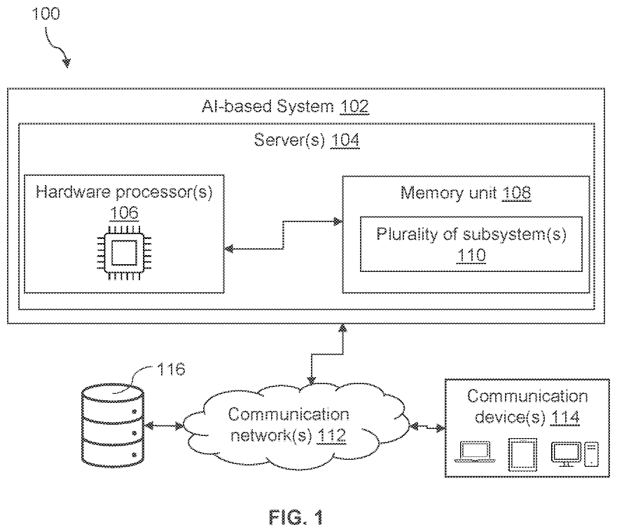

Referring now to the drawings, and more particularly to FIG. 1 through FIG. 5, where similar reference characters denote corresponding features consistently throughout the figures, there are shown preferred embodiments, and these embodiments are described in the context of the following exemplary system and/or method.

As used herein, the term “work items” refers to electronic records created to track, manage, and resolve user-reported issues. One or more work items may be, but not limited to, at least one of: one or more tickets, one or more incidents, one or more service requests, one or more change requests, and the like.

FIG. 1 illustrates an exemplary block diagram representation of a network architecture 100 depicting an artificial intelligence (AI)-based system 102 for resolving one or more work items in service management platforms, in accordance with an embodiment of the present disclosure.

According to an exemplary embodiment of the present disclosure, the network architecture 100 may include the artificial intelligence-based system 102, one or more databases 116, and one or more communication devices 114. The system 102, the one or more databases 116, and the one or more communication devices 114 may be communicatively coupled via one or more communication networks 112, ensuring seamless data transmission, processing, and decision-making. The term AI-based system 102 and the system 102 are used interchangeably throughout the description. The system 102 acts as a central processing unit within the network architecture 100, responsible for resolving the one or more work items in the service management platforms. The system 102 is configured to execute a set of computer-readable instructions that control a plurality of subsystems 110.

The present invention with the AI-based system 102 is configured to resolve the one or more work items in the service management platforms. The AI-based system 102 is initially configured to obtain work item data from the one or more communication devices 114 associated with the one or more first users. The terms one or more first users and one or more work item filers are used interchangeably throughout the description. The AI-based system 102 is further configured to create the one or more work items based on the work item data obtained from the one or more first users, using one or more language models. The AI-based system 102 is further configured to generate one or more queries for the one or more first users for receiving one or more responses comprising one or more missing details associated with the one or more work items from the one or more first users to comprehensively analyze an issue associated with the one or more work items.

The AI-based system 102 is further configured to generate one or more recommendations based on at least one of: the work item data and the received one or more responses associated with the one or more queries, using one or more machine learning models. The one or more recommendations comprise at least one of: one or more message updates and one or more metadata field updates. The AI-based system 102 is further configured to update the one or more work items based on the one or more recommendations. Updating the one or more work items comprises at least one of: adding a new message to the one or more work items, and updating one or more metadata fields associated with the one or more work items.

The AI-based system 102 is further configured to generate one or more troubleshooting responses based on an analysis of at least one of: the updated one or more work items, knowledge base documents, and historical resolutions, using the one or more machine learning models, to resolve the one or more work items. The one or more troubleshooting responses comprise at least one of: one or more troubleshooting steps and the one or more queries for the one or more first users to determine missing information that assist in generating accurate one or more troubleshooting steps.

In an exemplary embodiment, the system 102 comprises one or more servers 104. The one or more servers 104 may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or one or more hardware processors 106.

The one or more servers 104 comprise the one or more hardware processors 106 and a memory unit 108. The memory unit 108 is operatively connected to the one or more hardware processors 106. The memory unit 108 comprises a set of computer-readable instructions in the form of the plurality of subsystems 110, configured to be executed by the one or more hardware processors 106.

In an exemplary embodiment, the one or more hardware processors 106 may include, for example, microprocessors, microcomputers, microcontrollers, digital signal processors, central processing units, state machines, logic circuits, and/or any devices that manipulate data or signals based on operational instructions. Among other capabilities, the one or more hardware processors 106 may fetch and execute computer-readable instructions in the memory unit 108 operationally coupled with the system 102 for performing tasks such as data processing, input/output processing, and/or any other functions. Any reference to a task in the present disclosure may refer to an operation being or that may be performed on data. The one or more hardware processors 106 are high-performance processors capable of handling large volumes of data and complex computations. The one or more hardware processors 106 may be, but not limited to, at least one of: multi-core central processing units (CPU), graphics processing units (GPUs), and the like, which enhance an ability of the system 102 to process real-time data from one or more sources simultaneously.

In an exemplary embodiment, the one or more databases 116 may be configured to store and manage data related to various aspects of the system 102. The one or more databases 116 may store at least one of, but not limited to, the one or more work items, the one or more troubleshooting responses, any other information necessary for the functionality and optimization of the system 102, and the like. The one or more databases 116 serve as a centralized repository for critical data elements that are integral to the secure operation of the system 102, enabling efficient resolving of the one or more work items based on one or more troubleshooting responses.

The one or more databases 116 enable the system 102 to dynamically retrieve, analyze, and update the stored data in real-time, for resolving the one or more work items based on the one or more troubleshooting responses. The one or more databases 116 may include different types of databases such as, but not limited to, relational databases (e.g., Structured Query Language (SQL) databases such as PostgresDB and Oracle® databases), non-Structured Query Language (NoSQL) databases (e.g., MongoDB, Cassandra), time-series databases (e.g., InfluxDB), an OpenSearch database, object storage systems (e.g., Amazon® S3), and the like.

The one or more databases 116 may store, but not constrained to, at least one of: support documents, product documents, installation guides, troubleshooting guides, sales brochures, one or more past work items, and other documents. These documents may be one of: external (visible to both the work item filer/first user and a support team) and internal (visible only to the support team/second user). The term support team and the one or more second users may be used interchangeably through the description. The one or more past work items act as a repository of valuable knowledge that is configured to resolve the one or more work items. The one or more work items may be pooled together from service management platforms in a business. For instance, the business may be configured with two service management platforms: one for communication with external businesses and another for internal engineering teams. The combined knowledge of both the service management platforms may assist in resolving the one or more work items.

Internal conversations such as, but not constricted to, at least one of: Slack®, internal mailing lists, and codebases are employed during the lifecycle of the one or more work items to resolve an open work item associated with the one or more work items. By ingesting all the data stored in the one or more databases 116, the system 102 synthesizes a knowledge graph, which aids the computation of work item update recommendations.

In an exemplary embodiment, the one or more communication devices 114 are configured to enable one or more first users or the second users, to interact with the system 102. The one or more communication devices 114 may be digital devices, computing devices, and/or networks. The one or more communication devices 114 may include, but not limited to, a mobile device, a smartphone, a personal digital assistant (PDA), a tablet computer, a phablet computer, a wearable computing device, a virtual reality/augmented reality (VR/AR) device, a laptop, a desktop, and the like.

In an exemplary embodiment, the one or more communication devices 114 may be associated with, but not limited to, one or more service providers, one or more customers, an individual, an administrator, a vendor, a technician, a specialist, an instructor, a supervisor, a team, an entity, an organization, a company, a facility, a bot, any other user, and combination thereof. The entity, the organization, and the facility may include, but not limited to, an e-commerce company, online marketplaces, service providers, retail stores, a merchant organization, a logistics company, warehouses, transportation company, an airline company, a hotel booking company, a hospital, a healthcare facility, an exercise facility, a laboratory facility, a company, an outlet, a manufacturing unit, an enterprise, an organization, an educational institution, a secured facility, a warehouse facility, a supply chain facility, any other facility/organization and the like.

In an exemplary embodiment, the one or more communication networks 112 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fiber optic network, a satellite network, a cloud computing network, a combination of networks, and the like. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including fourth generation (4G) technologies and fifth generation (5G) technologies), Bluetooth®, ZigBee®, long-range wide area network (LoRaWAN), satellite communication, radio frequency identification (RFID), 6G (sixth generation) networks, advanced IoT protocols, mesh networks, non-terrestrial networks (NTNs), and the like.

In an exemplary embodiment, the system 102 may be implemented by way of a single device or a combination of multiple devices that may be operatively connected or networked together. The system 102 may be implemented with hardware or a suitable combination of hardware and software.

Though few components and the plurality of subsystems 110 are disclosed in FIG. 1, there may be additional components and subsystems which is not shown, such as, but not limited to, ports, routers, repeaters, firewall devices, network devices, the one or more databases 116, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the system 102, and the one or more communication devices 114 connected to the one or more databases 116, one skilled in the art can envision that the system 102, and the one or more communication devices 114 may be connected to several user devices located at various locations and several databases via the one or more communication networks 112.

Those of ordinary skilled in the art will appreciate that the hardware depicted in FIG. 1 may vary for particular implementations. For example, other peripheral devices such as an optical disk drive and the like, the local area network (LAN), the wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102 as is unique to the present disclosure or necessary for an understanding of the present disclosure is depicted and described. The remainder of the construction and operation of the system 102 may conform to any of the various current implementations and practices that were known in the art.

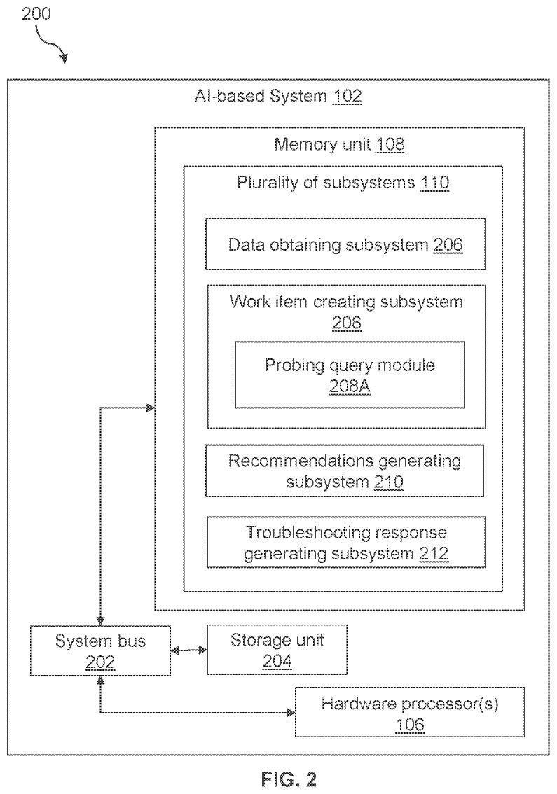

FIG. 2 is a detailed view 200 of the AI-based system 102, such as those shown in FIG. 1, for resolving the one or more work items in the service management platforms, in accordance with an embodiment of the present disclosure.

In an exemplary embodiment, the system 102 comprises the one or more servers 104, the memory unit 108, and a storage unit 204. The one or more hardware processors 106, the memory unit 108, and the storage unit 204 are communicatively coupled through a system bus 202 or any similar mechanism. The system bus 202 functions as the central conduit for data transfer and communication between the one or more hardware processors 106, the memory unit 108, and the storage unit 204. The system bus 202 facilitates the efficient exchange of information and instructions, enabling the coordinated operation of the system 102. The system bus 202 may be implemented using various technologies, including but not limited to, parallel buses, serial buses, and high-speed data transfer interfaces such as, but not limited to, at least one of a: universal serial bus (USB), peripheral component interconnect express (PCIe), and similar standards.

In an exemplary embodiment, the memory unit 108 is operatively connected to the one or more hardware processors 106. The memory unit 108 comprises the plurality of subsystems 110 in the form of programmable instructions executable by the one or more hardware processors 106. The plurality of subsystems 110 comprises a data obtaining subsystem 206, a work item creating subsystem 208, a recommendations generating subsystem 210, and a troubleshooting response generating subsystem 212.

The one or more hardware processors 106 associated within the one or more servers 104, as used herein, means any type of computational circuit, such as, but not limited to, the microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 106 may also include embedded controllers, such as generic or programmable logic devices or arrays, application-specific integrated circuits, single-chip computers, and the like.

The memory unit 108 may be the non-transitory volatile memory and the non-volatile memory. The memory unit 108 may be coupled to communicate with the one or more hardware processors 106, such as being a computer-readable storage medium. The one or more hardware processors 106 may execute machine-readable instructions and/or source code stored in the memory unit 108. A variety of machine-readable instructions may be stored in and accessed from the memory unit 108. The memory unit 108 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 108 includes the plurality of subsystems 110 stored in the form of machine-readable instructions on any of the above-mentioned storage media and may be in communication with and executed by the one or more hardware processors 106.

The storage unit 204 may be a cloud storage or the one or more databases 116 such as those shown in FIG. 1. The storage unit 204 may store, but not limited to, recommended course of action sequences dynamically generated by the system 102. The action sequences comprise data obtaining, work item creation, recommendations generating, troubleshooting response generating, and the like. Additionally, the storage unit 204 may retain previous action sequences for comparison and future reference, enabling continuous refinement of the system 102 over time. The storage unit 204 may be any kind of database such as, but not limited to, relational databases, dedicated databases, dynamic databases, monetized databases, scalable databases, cloud databases, distributed databases, any other databases, and a combination thereof.

The system 102 is configured to manage the one or more work items on the service management platforms (e.g., Salesforce® service cloud). The service management platforms enable individual-business communication for at least one of: complaints, feature requests, and support needs. The organizations use the service management platforms internally for Human Resources (HR) requests and employee task tracking. The businesses maintain separate service management platforms for external purposes and internal purposes to effectively manage different workflows. The system 102 is configured to integrate with all the service management platforms.

The work item filer or the one or more first users may be, but not constricted to, one of: an individual of the businesses, an employee, a business partner, and the like. The one or more work items may be filed by automated systems. The one or more work items may be filed by at least one of: the individual, a group of individuals, a role account, the automated systems, Artificial Intelligence (AI) bots, and the like. The support teams or the one or more second users are dedicated teams that monitor, update, and resolve both internal one or more work items and external one or more work items throughout the lifecycle. May be multiple teams may participate in the one or more work items. For instance, the support team, a sales team, and an engineering team may collectively resolve the one or more work items.

In an exemplary embodiment, the system 102 is configured with one or more artificial intelligence models. The one or more artificial intelligence models may comprise, but not constrained to, at least one of: one or more Natural Language Processing (NLP) models, one or more Neural Networks (NNs), one or more Large Language Models (LLMs), one or more reinforcement learning models, and the like.

The plurality of subsystems 110 includes the data obtaining subsystem 206 that is communicatively connected to the one or more hardware processors 106. The data obtaining subsystem 206 is configured to obtain the work item data from the one or more communication devices 114 associated with the one or more first users. The one or more communication devices 114 are configured to enable the one or more first users to interact with the system 102, and may be digital devices, computing devices, and/or networks including a mobile device, a smartphone, a personal digital assistant (PDA), a tablet computer, a phablet computer, a wearable computing device, a virtual reality/augmented reality (VR/AR) device, a laptop, a desktop, and the like. For example, a customer named Jake experiences a server memory issue and submits a support request via email from his laptop, and the data obtaining subsystem 206 receives this email containing the issue description, product information, and any attached screenshots through the communication network, making this work item data available for the work item creating subsystem 208 to process and create a structured work item.

The plurality of subsystems 110 includes the work item creating subsystem 208 that is communicatively connected to the one or more hardware processors 106. The work item creating subsystem 208 is configured to create the one or more work items based on obtained work item data from the work item filer/the one or more first users.

The work item creating subsystem 208 is configured with the one or more NLP models to recognize work item descriptions, thereby extracting relevant data from the work item data. The work item creating subsystem 208 is configured to create structured one or more work items based on the work item data provided by the work item filer. The structured one or more work items may include, but not limited to, at least one of: subject and description fields, along with metadata fields such as creation time and filer data, which may include a user, a group, a role account, a bot, and an automation). The language model is an artificial intelligence model configured to recognize work item descriptions and extract relevant data from the work item data. The work item creating subsystem 208 is configured to create the one or more work items based on the work item data provided by the work item filer/first user, and is configured to register the one or more work items through at least one of: a work item filer input from at least one of: manual entry, electronic mail, text communication, audio communication, voice communication, video communication, and an Application Programming Interface (API).

For creating the one or more work items, as structured, based on the work item data, using the one or more language models, the work item creating subsystem 208 is further configured to: (a) recognize one or more work item descriptions from the work item data obtained from the one or more first users through at least one of: manual entry, an electronic mail, a text communication, an audio communication, a video communication, and the application programming interface, using the one or more language models; (b) extract relevant data from the work item data based on the recognized one or more work item descriptions; and create the one or more work items being structured based on the extracted relevant data, wherein the structured one or more work items include at least one of: subject and description fields, along with the one or more metadata fields.

The structured one or more work items may also include an identity of the work item filer and status indicators such as open, assigned, and resolved. Additionally, the structured one or more work items may also include priority levels (e.g., P₀, P₁,) and severity levels. The metadata fields may also pertain to the identity of the work item filer and the associated environment, including a name of a Cloud Service Provider (CSP). The structured one or more work items may include product information such as product name, version number, and configuration. Optional attachments may be incorporated including, but not limited to, at least one of: Portable Document Formats (PDFs), screenshots, audio transcripts, spreadsheets, data dumps, other files, and images, other equivalent forms of digital content, and the like.

For example, when a customer named Jake submits an email describing a server memory issue with an attached screenshot, the work item creating subsystem 208 uses the one or more language models to recognize the issue description, extract relevant information such as product name, version number, error details, and environment information, and create a structured work item with subject field containing “Server Memory Issue”, description field containing the detailed problem, metadata fields including creation time, Jake's identity, status as “open”, priority level P1, and the attached screenshot as optional document.

The work item creating subsystem 208 is configured with a probing query module 208A. The probing query module 208A is configured to generate one or more queries for the work item filer (first user) for receiving missing details to comprehensively understand an issue. Further, the work item filer provides one or more responses associated with the one or more queries, thereby presenting additional clarifications to refine issue description in the structured one or more work items.

The one or more queries are probing questions generated by the probing query module 208A associated with the work item creating subsystem 208, and the one or more first users are work item filers who may be an individual of the businesses, an employee, a business partner, or automated systems including AI bots. The probing query module 208A is configured to generate the one or more queries for the work item filer for receiving missing details to comprehensively understand an issue, and the work item filer provides one or more responses associated with the one or more queries, thereby presenting additional clarifications to refine issue description in the structured one or more work items. For example, when a customer named Jake reports a server memory issue but does not provide details about when the problem started, the probing query module 208A generates a query such as “When was the magenta cache server restarted?” to receive the missing information from Jake, and Jake's response helps the system generate accurate troubleshooting steps like “Set the value of Gflag—num_replicas to 3.”

The plurality of subsystems 110 includes the recommendations generating subsystem 210 that is communicatively connected to the one or more hardware processors 106. The recommendations generating subsystem 210 is configured to generate one or more recommendations based on the work item data and the received one or more responses associated with the one or more queries. The one or more recommendations may comprise, but not constrained to, at least one of: one or one or more message updates, one or more metadata field updates, and the like. The one or more recommendations are generated based on the one or more past work items stored in the one or more databases 116. The structured one or more work items may be updated based on the one or more recommendations in two ways by the work item filer and the support team: a) a new message is appended to the structured one or more work items, and b) the metadata fields associated with the structured one or more work items are updated.

The one or more message updates are updates to the structured one or more work items in the form of a blob of text, for instance, “Hi Jake! Looks like a cluster is down. Restarting it with twice as much main memory is likely to resolve a problem.” Such text may be generated by one of: members of the support team/second users (support team members) and the work item filer/first users. The one or more message updates are categorized into three distinct types: a) one or more internal message updates: the members of the support team may update the structured one or more work items with the one or more updates visible only to the members of the support team; not visible to the work item filer, b) one or more external message updates: the one or more updates are completed by the members of the support team and are visible to both support team members and the work item filer, and c) one or more incoming message updates: the structured one or more work items may also be updated by the work item filer.

The one or more metadata field updates are pertained to changes in work item metadata, for instance, the status (open vs assigned vs resolved vs . . . ) and priority (P₀, P₁, . . . ). The one or more metadata field updates are categorized into three distinct types: a) one or more internal metadata updates: the members of the support team may update the structured one or more work items. The one or more internal metadata updates are visible only to the members of the support team; not visible to the work item filer, b) one or more external metadata updates: the one or more metadata updates are completed by the members of the support team and are visible to both the support team members and the work item filer, c) one or more incoming metadata updates: the structured one or more work items may also be updated by the work item filer.

The one or more recommendations are visible to the members of the support team through, but not constricted to, at least one of: a web portal provided by the system 102, communication platforms such as Slack®, an application on a service management platform (an application on Salesforce®), an integration with the service management platforms (by extending Salesforce database and configuration), and the like. The one or more recommendations may be one of: pull-based and push-based. For the pull-based, the support team members interact with a Graphical User Interface (GUI) element associated with the one or more communication devices 114 to fetch and display the one or more recommendations for the work item filer. In the push-based, the one or more recommendations are directly visible to the support team members without requesting the system 102 to fetch and display the one or more recommendations.

The one or more recommendations are visible only to the members of the support team. The one or more recommendations may not be visible to the work item filer. The one or more work item updates (the one or more message updates and the one or more metadata field updates) are visible to the work item filer when the one or more work item updates are externally visible. The support team members are allowed to at least one of: modify, approve, and reject the one or more message updates. The support team members are also allowed to adjust the one or more metadata field updates before the one or more work item updates are visible to the work item filer.

During the lifecycle of the one or more work items, the system 102 continually generates the one or more recommendations regarding the one or more message updates and the one or more metadata field updates that may be one of: one or more semi-automatic updates and one or more automatic updates. In the one or more semi-automatic updates, the support team may ingest, modify, and use the one or more recommendations to construct at least one of: an actual message update (internal or external) of the one or more message updates, and an actual metadata field update (internal or external) of the one or more metadata field updates. In the one or more automatic updates, the system 102 may perform at least one of: the one or more message updates (internal or external) and the one or more metadata field updates (internal or external) directly without the approval of the support team members.

In an aspect, the one or more machine learning models such as at least one of: one or more Natural Language Processing (NLP) models, one or more Neural Networks (NNs), one or more Large Language Models (LLMs), and one or more reinforcement learning models, which are configured to generate the one or more recommendations comprising at least one of: one or more message updates and one or more metadata field updates. The LLMs generate the one or more recommendations by retrieving relevant past snapshots/the one or more past work items and documents from clusters and indexes using software like Qdrant, BM25, Vespa, or Elastic Search, and then extracting troubleshooting steps and probing questions which may be a verbatim copy of sentences from one or more sections of one or more knowledge base articles, or they may be a paraphrasing of such sentences, or they may be generated by the recommendations generating subsystem 210, or any combination of these. The LLMs also compute metadata update recommendations by predicting updated values of metadata fields like priority and severity, and compute status change recommendations by predicting a value for status comprising at least one of: open, customer confirmation pending, waiting for customer to answer questions, and resolved. For example, when a customer named Jake reports a server memory issue, the LLMs analyze the work item data and retrieve relevant past snapshots and knowledge base documents, then generate a message update recommendation such as “Hi Jake! It looks like a magenta cache server in your installation is running out of memory. Try setting the value of Gflag—num\_replicas to 3” along with a metadata field update recommendation assigning priority P₁ with an expected response time of 48 hours, and the LLMs may also generate 1 probing questions such as “When was the magenta cache server restarted?” to gather missing information for accurate troubleshooting.

The plurality of subsystems 110 includes the troubleshooting response generating subsystem 212 that is communicatively connected to the one or more hardware processors 106. The troubleshooting response generating subsystem 212 is configured to generate the one or more troubleshooting responses based on the analysis of at least one of: the updated one or more work items, knowledge base documents, and historical resolutions, using the one or more machine learning models, to resolve the one or more work items.

The troubleshooting response generating subsystem 212 is a component of the AI-based system 102 configured with one or more neural networks, one or more large language models, and one or more reinforcement learning models to generate the one or more troubleshooting responses based on the updated one or more work items, knowledge base documents comprising internal and external documents such as support documents, product documents, installation guides, troubleshooting guides, and historical resolutions from past work items stored in the one or more databases 116. The one or more neural networks are configured to create relationships between at least one of: the one or more work items, support documents, and past resolutions for contextual troubleshooting, while the one or more large language models are configured to generate step-by-step troubleshooting instructions based on the one or more past work items and real-time user input, and the one or more reinforcement learning models continuously improve troubleshooting accuracy by learning from expert corrections and work item resolutions. The one or more troubleshooting responses include the one or more troubleshooting steps for execution by at least one of: the members of the support team and the work item filer, and the one or more queries which are probing questions directed at the work item filer to find the missing information that may assist in generating accurate one or more troubleshooting steps.

For example, when a customer named Jake reports a server memory issue, the troubleshooting response generating subsystem 212 analyzes the updated work item, retrieves relevant knowledge base documents and historical resolutions, and generates a troubleshooting response such as “Hi Jake! It looks like a magenta cache server in your installation is running out of memory. Try setting the value of Gflag—num\_replicas to 3” along with a probing question “When was the magenta cache server restarted?” to gather missing information for accurate troubleshooting.

For generating the one or more troubleshooting responses, using the one or more machine learning models, the troubleshooting response generating subsystem 212 is further configured to: (a) extract one or more features comprising at least one of: issue descriptors, contextual parameters, and metadata, from the updated one or more work items; (b) retrieve the one or more historical work items and corresponding resolution data from one or more knowledge sources based on the extracted one or more features; (c) generate one or more similarity representations between the updated one or more work items and the one or more historical work items, using the one or more neural networks; (d) identify one or more relevant historical work items and associated resolution patterns based on the one or more similarity representations; (e) determine one or more relationships between the updated one or more work items, the one or more historical work items, and the corresponding resolution data, using the one or more neural networks; and (f) generate the one or more troubleshooting steps for the one or more first users, based on the determined one or more relationships.

The troubleshooting response generating subsystem 212 is a component of the AI-based system configured with one or more neural networks, one or more large language models, and one or more reinforcement learning models to generate the one or more troubleshooting responses based on the updated one or more work items. The one or more features comprising issue descriptors, contextual parameters, and metadata are extracted from the updated work items to identify the nature of the problem, environment details, and relevant work item information. The one or more historical work items are past work items stored in the one or more databases 116 that act as a repository of valuable knowledge configured to resolve the one or more work items, and the corresponding resolution data includes past resolutions and troubleshooting steps that successfully addressed similar issues. The one or more knowledge sources comprise at least one of: internal and external knowledge base documents, the one or more past work items and one or more active work items, user databases, and various technical repositories such as codebases, conversation systems, forums, groups, logs, and telemetry data.

The one or more neural networks are configured to create relationships between at least one of: the one or more work items, support documents, and past resolutions for contextual troubleshooting, and generate one or more similarity representations by computing semantic similarity between problem scenarios, semantic similarity between customer configuration contexts, semantic similarity between troubleshooting steps, semantic similarity between actions by support engineers and customers, semantic similarity between questions and answers, and similarity of product configuration. The one or more relevant historical work items and associated resolution patterns are identified based on the similarity representations using clustering techniques like Hierarchical Agglomerative Clustering, and the snapshots are indexed using techniques like BM25 and embeddings for retrieving snapshots based on semantic similarity.

For example, when a customer named Jake reports a server memory issue, the system extracts features such as issue descriptor “memory issue”, contextual parameter “magenta cache server”, and metadata including product version and configuration, then retrieves historical work items with similar memory-related problems, generates similarity representations to identify the most relevant past cases, determines relationships between Jake's current issue and past resolutions, and generates troubleshooting steps such as “Set the value of Gflag—num\_replicas to 3” based on successful resolutions from similar historical work items.

The troubleshooting response generating subsystem 212 is configured to forward the one or more troubleshooting responses to the work item filer displayed on the GUI associated with the one or more communication devices 114.

The troubleshooting response generating subsystem 212 also provides status updates (e.g., open, assigned, resolved) to at least one of: the work item filer, the support team, and the like. The one or more work items remain open until the work item filer confirms that the issue is resolved. Upon resolution/resolving of the one or more work items, a metadata field labeled “status” is updated again to a predefined value (e.g., one of: “resolved” and “closed”) to signify the completion of the work item lifecycle. This update restricts any further modifications, preventing the additional one of: one or more message updates and one or more metadata field updates from being applied to the one or more work items.

Maintaining the one or more work items as open is a process where the one or more work items remain in an active state with status indicator “open” until the one or more first users who are work item filers confirm whether the issue associated with the one or more work items is resolved. Updating the status of the one or more metadata fields to a pre-defined value is a process where upon resolution of the one or more work items, a metadata field labeled “status” is updated to a predefined value comprising at least one of: “resolved” and “closed” to signify the completion of the work item lifecycle, wherein this status update restricts any further modifications and prevents the additional one or more message updates and one or more metadata field updates from being applied to the one or more work items. Continuing the status update of the one or more work items is a process where if the issue persists, the one or more work item updates continue with further exchanges between the one or more first users who are work item filers and at least one of: the one or more second users who are members of the support team and the AI-based system until a final resolution is reached, and once the issue is successfully addressed, the one or more work items are marked as resolved and closed.

If the issue persists, the one or more work item updates continue with further exchanges between the work item filer and one of: the support team and the system 102 until a final resolution is reached. Once the issue is successfully addressed, the one or more work items are marked as resolved and closed. The troubleshooting response generating subsystem 212 is configured with the one or more reinforcement learning models. The one or more reinforcement learning models continuously improve troubleshooting accuracy by learning from expert corrections and work item resolutions.

The one or more reinforcement learning models are artificial intelligence models associated with the troubleshooting response generating subsystem 212 that are configured to continuously optimize troubleshooting accuracy by learning from expert corrections and work item resolutions. The expert corrections are modifications, approvals, and rejections made by the members of the support team to the one or more message updates and adjustments made to the one or more metadata field updates before the one or more work item updates are visible to the work item filer. The work item resolutions are successful completions of the work item lifecycle where the one or more work items are marked as resolved and closed after the work item filer confirms that the issue is resolved. The one or more reinforcement learning models learn from these expert corrections and work item resolutions to improve the accuracy of future troubleshooting responses, adapting to evolving issue patterns and refining the troubleshooting approach based on real-time work item updates.

For instance, consider Work item 1 associated with the one or more work items. The Work item 1 evolves as sequence (IT, Message1, Message2, Meta1, Message3, Meta2, Message4, . . . ), where IT denotes an initial work item associated with the one or more work items with an initial message and metadata, {Message1, Message2, Message3, . . . } denote the one or more message updates, and {Meta1, Meta2, . . . } denote the one or more metadata field updates. Histories of the Work item 1 are depicted.

Work item 1 with the one or more updates:
(IT)
(IT, Message1)
(IT, Message1, Message2)
(IT, Message1, Message2, Meta1)
(IT, Message1, Message2, Meta1, Message3)
(IT, Message1, Message2, Meta1, Message3, Meta2)
(IT, Message1, Message2, Meta1, Message3, Meta2, Message4) . . . and so on.

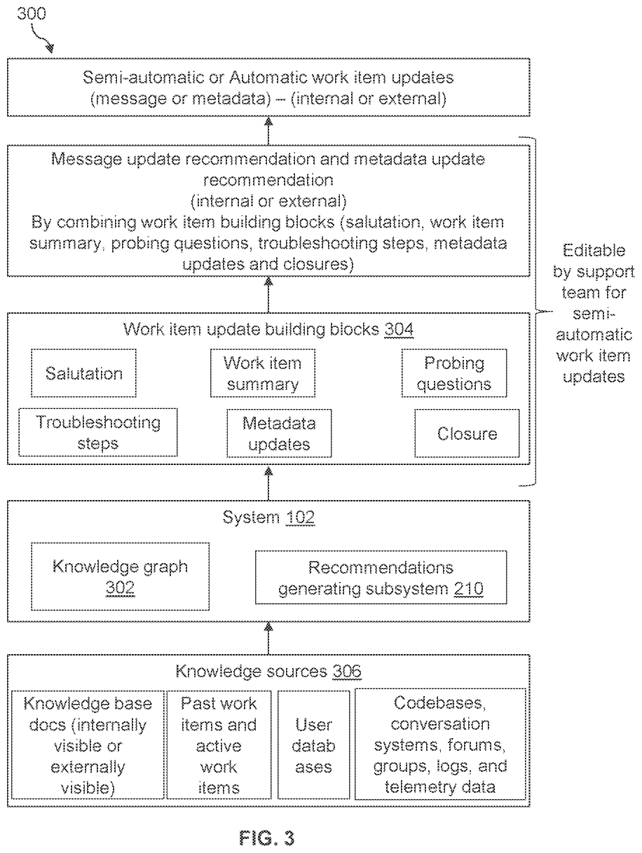

FIG. 3 illustrates an exemplary flow diagram representation 300 of resolving the one or more work items in the service management platforms, in accordance with an embodiment of the present disclosure.

In an exemplary embodiment, the system 102 employs one or more knowledge sources 306 from the one or more databases 116, which may include, but not limited to, at least one of: internal and external knowledge base documents, the one or more past work items and one or more active work items, user databases, and various technical repositories such as codebases, conversation systems, forums, groups, logs, and telemetry data. This structured data and unstructured data are processed by the system 102. The system 102 comprises the knowledge graph 302 and the recommendations generating subsystem 210. The knowledge graph 302 organizes and interconnects the structured data and the unstructured data to provide contextual insights, while the recommendations generating subsystem 210 analyzes work item content and historical patterns to suggest optimal one or more recommendations.

The troubleshooting response generating subsystem 212 is further configured to utilize the knowledge graph 302 for generating the one or more troubleshooting responses, by: (a) synthesizing the knowledge graph 302 based on the work item data stored in one or more knowledge sources 306, wherein the knowledge graph 302 is a graph structure with nodes and edges, wherein the nodes indicate one or more semantic concepts comprising at least one of: the one or more work items, one or more historical work items, the one or more troubleshooting steps, the knowledge base documents comprising internal and external knowledge base documents, and the one or more queries, and wherein the edges indicate one or more relationships between the nodes; (b) mapping one or more elements of the work item data to corresponding nodes in the knowledge graph 302; (c) traversing the knowledge graph 302 to identify one or more related nodes corresponding to one or more relevant historical work items and associated resolution data; (d) extracting the one or more troubleshooting steps associated with the identified nodes based on the traversed knowledge graph 302; and (e) generating the one or more troubleshooting responses based on the extracted one or more troubleshooting steps.

The one or more knowledge sources 306 may include at least one of: internal and external knowledge base documents, the one or more past work items and one or more active work items, user databases, and various technical repositories such as codebases, conversation systems, forums, groups, logs, and telemetry data. By ingesting all the data stored in the one or more databases 116, the troubleshooting response generating subsystem 212 synthesizes the knowledge graph 302, which aids the computation of work item update recommendations. The synthesizing step creates the knowledge graph 302 by ingesting data from the knowledge sources 306, the mapping step associates elements of the current work item data to corresponding nodes in the knowledge graph 302, the traversing step navigates through the edges to identify related nodes corresponding to relevant historical work items and associated resolution data, the extracting step retrieves the troubleshooting steps associated with the identified nodes, and the generating step produces the troubleshooting responses based on the extracted troubleshooting steps.

For example, when a customer named Jake reports a server memory issue, the system maps Jake's work item to a node in the knowledge graph 302, traverses the edges to identify related nodes such as a specific knowledge base article about memory issues and a specific set of troubleshooting steps from past similar work items, extracts the troubleshooting steps such as “Set the value of Gflag—num\_replicas to 3” from the identified nodes, and generates a troubleshooting response such as “Hi Jake! It looks like a magenta cache server in your installation is running out of memory. Try setting the value of Gflag—num\_replicas to 3.”

The system 102 enables the dynamic construction of work item update building blocks 304, which include six components such as, but not constricted to, at least one of: salutations, work item summaries, probing questions (one or more queries), the one or more troubleshooting steps, the one or more metadata field updates, closure statements, and the like. The work item update building blocks 304 serve as modular components that may be assembled intelligently to form coherent and contextually relevant one or more troubleshooting responses.

A message update recommendation and metadata update recommendation layer leverage the work item update building blocks 304 to generate well-structured responses, which may be one of: internal (for support teams) and external (for user communication). The system 102 supports the one or more semi-automated updates and the one or more automated updates. By automating the formulation of the one or more troubleshooting responses using historical knowledge and AI-driven insights, the system 102 enhances efficiency, reduces response times, and maintains consistency across support interactions. The system 102 is configured to optimize user support workflows, ensuring that the one or more work items are addressed quickly, accurately, and with minimal user intervention, thereby improving overall service quality and user satisfaction

Each work item update building block 304 of the one or more work item update building blocks 304 is populated with at least one of: 0, 1 and more options. For each work item update building block 304, the support team members may choose at least one of: 0, 1 and more options. Additionally, all options are editable: The members of the support team may augment the options by one of: introducing own options, replacing existing options with a more suitable option, and deleting some options. Whenever the option is chosen in any work item update building block 304, the options in other work item update building blocks 304 may also be changed dynamically by the system 102. Whenever the option is chosen in any work item update building block 304, at least one of: the message update recommendation and the metadata update recommendation may be automatically updated to reflect the option. The support team members may edit at least one of: the message updates and the one or more metadata field updates.

The one or more recommendations associated with the one or more metadata field updates specify a metadata field name, along with a recommended value. for instance, status =resolved. The one or more metadata field updates may be recommended together. For instance, in addition to the status, the one or more recommendations for another metadata field called “Eligible_for_kb_docs” may be true if the system 102 determines that the work item contents quantifies as a suitable candidate for one of: creating and updating an article in a knowledge base. The one or more recommendations associated with the one or more message updates are a composition of the work item update building blocks 304 into a coherent message.

For instance, the message: “Hi jake! It looks like a magenta cache server in your installation is running out of memory. Try setting the value of Gflag—num_replicas to 3. Hope the one or more troubleshooting steps outlined above resolve the one or more work items. Please do not hesitate to contact us if you need further assistance. Mike (support engineer for business B).”

An instance of the work item update building blocks 304 is given below:

The salutation: “Hi jake!”

The work item summary: “It looks like magenta cache server is running out of memory.”

The probing questions: “When was the magenta cache server restarted?”. The probing questions are directed at the work item filer to find the missing information that may assist in generating accurate one or more troubleshooting steps.

The one or more troubleshooting steps: “Set the value of Gflag—num_replicas to 3.” The troubleshooting steps for the support team are steps employed for execution by at least one of: the members of the support team and the work item filer.

The one or more metadata field updates: “The one or more work items have been assigned priority P₁ and we expect to get back to you in 48 hours.”

The closure: “Hope the troubleshooting steps outlined above resolve the one or more work items. Please do not hesitate to contact us if you need further assistance.—Mike (support engineer for x)”. The closure may also include instructions for escalation and reopening the one or more work items.

A meaningful first response is a first ever response (an external work item update, visible to the work item filer of the one or more work items) is called meaningful first response. Follow-up responses are configured with the same six components but with a potentially richer set of the probing questions and the one or more troubleshooting steps. The processing of the work item/ticket and he work item update building blocks 304 are explained below in detailed manner.

In an aspect, upon creating the one or more work items the work item creating subsystem 208 is further configured to process the one or more work items, by: augmenting the one or more work items with one or more attributes comprising at least one of: transcripts of video calls pertaining to an issue in the one or more work items, conversations in chat systems pertaining to the issue in the one or more work items, one or more documents related to the one or more work items, and one or more relevant work items. The one or more attributes are additional pieces of information that augment the work item to provide a more complete picture of the work item's journey, wherein the transcripts of video calls are transcripts of video calls such as Zoom calls pertaining to the issue in the work item, the conversations in chat systems are conversations in chat systems like Slack that pertain to the issue in the work item, the one or more documents related to the work item are support documents, product documents, installation guides, troubleshooting guides, and other documents stored in the one or more databases, and the one or more relevant work items are other work items related to the current work item that may be pooled together from service management platforms in a business to assist in resolving the one or more work items.

The work item creating subsystem 208 is further configured to augment the one or more work items with one or more additional attributes to record contextual metadata related to at least one of: product version, product configuration, user information, deployment environment related information, source configuration data, user relationship management systems, and product backend. The contextual metadata is additional attributes that augment the work item to record information related to the work item's environment and context, wherein the product version is the specific version number of the product associated with the issue, the product configuration is the specific settings and setup of the product, the user information is data about the work item filer such as identity, role, and organization, the deployment environment related information is data about the environment where the product is deployed including the name of a Cloud Service Provider (CSP), the source configuration data is configuration settings from the source systems, the user relationship management systems are Customer Relationship Management (CRM) systems that store customer-related data, and the product backend is the backend systems and infrastructure supporting the product.

The work item creating subsystem 208 is further configured to mask sensitive information including personally identifiable information by at least one of: substituting the sensitive information with one or more generic identifiers and redacting the sensitive information. The sensitive information including personally identifiable information (PII) is confidential data that requires protection. Masking is the process of obfuscating the sensitive information by substituting the sensitive information with one or more generic identifiers such as replacing social security numbers with a generic identifier like “\” and replacing credit card numbers with a generic identifier like “\”, or by redacting the sensitive information to remove it entirely from the work item, and wherein PII detection, substitution, and redaction can be done by configuring and tuning existing software suited for such purpose or by building a custom engine.

The work item creating subsystem 208 is further configured to remove noisy and repetitive information from the one or more work items, using the one or more language models. The noisy and repetitive information comprise at least one of: signatures in the electronic mail, parts of the electronic mail that quote previous electronic mails in an electronic mail thread, and electronic mails with operational steps. The noisy and repetitive information is extraneous data that clutters the work item and does not contribute to understanding or resolving the issue, wherein signatures in the electronic mail are sign-off blocks appended at the end of emails containing sender details like name, title, and contact information, parts of the electronic mail that quote previous electronic mails in an electronic mail thread are sections that replicate earlier messages in a conversation chain creating redundant content, and electronic mails with operational steps are messages containing administrative actions like scheduling video calls or informing the customer that a new support engineer has been assigned to the work item, and the one or more language models remove this noisy and repetitive information through ticket cleanup to ensure only relevant issue-related content remains in the work item.

Ticket cleanup can be done with the help of a rule-based system, Machine Learning or Large Language Models (LLMs), which analyze the text content of work items to distinguish between relevant issue-related information and extraneous data that does not contribute to understanding or resolving the issue. For example, when a customer named Jake sends an email about a server memory issue that includes his email signature with name, title, phone number, and company logo, along with quoted text from three previous emails in the thread and a message about scheduling a Zoom call, the language models identify and remove these noisy elements while preserving only the core issue description about the memory problem, ensuring that the work item contains only relevant content for troubleshooting.

The work item creating subsystem 208 is further configured to compute a credibility score of the one or more work items, using at least one of: the one or more language models, one or more machine learning models, and one or more rule-based models. The credibility score is a measure of trustworthiness of contents of the one or more work items derived from one or more signals comprising at least one of: first user confirmation indicating whether the issue was resolved, and frequency of references to at least one of: the knowledge base documents and the one or more troubleshooting steps across work items similar to the one or more work items. In an embodiment, the one or more signals may be considered at least one of: each independent signal and a combination of the two or more signals. The language models analyze the work item contents to identify signals such as customer confirmation by detecting phrases or metadata indicating resolution status, and compute the frequency of references by comparing the current work item against similar past work items stored in the one or more databases 116 to determine how often the same knowledge base documents or troubleshooting steps have been referenced and successfully applied. The credibility score can be computed with the help of a rule-based system, Machine Learning or Large Language Models (LLMs), and may be a numerical range between 0 and 1, or between 0% and 100%, or quantized into a small number of buckets such as Low, Medium, High. For example, when a customer named Jake reports a server memory issue, the language models compute a credibility score by analyzing whether similar past work items with the same troubleshooting step “Set the value of Gflag—num\_replicas to 3” resulted in confirmed resolutions by customers, and if this troubleshooting step has been frequently referenced and confirmed as successful across multiple similar work items, the credibility score will be high, indicating that the contents of Jake's work item and the associated troubleshooting steps are trustworthy.

The work item creating subsystem 208 is further configured to compute a completeness score of the one or more work items, using at least one of: the one or more language models, one or more machine learning models, and one or more rule-based models. The completeness score is a measure of completeness of troubleshooting path information available in the one or more work items derived from the one or more signals comprising at least one of: absence and presence of transcripts of video chats, absence and presence of descriptions of actual steps carried out by at least one of: the one or more first users and one or more second users, absence and presence of links to related work items and relevant knowledge base documents, and absence and presence of attachments comprising at least one of: logs, screenshots, errors, and stacktraces. The language models analyze the work item contents to detect and evaluate these signals by examining whether the work item contains actual video chat transcripts, whether the descriptions include concrete diagnostic steps versus vague references to actions taken, and whether there are explicit links to related work items or knowledge base articles that provide additional troubleshooting context. The completeness score can be computed with the help of a rule-based system, Machine Learning or Large Language Models (LLMs), and may be a numerical range between 0 and 1, or between 0% and 100%, or quantized into a small number of buckets such as Low, Medium, High. For example, when a customer named Jake reports a server memory issue, the language models compute a completeness score by analyzing whether Jake's work item contains a transcript of a Zoom call with the support engineer, whether the work item includes actual diagnostic steps such as “ran memory profiler and observed 95% utilization” rather than just “checked memory”, and whether there are links to related work items about similar memory issues or relevant knowledge base documents about memory troubleshooting, and if all these elements are present the completeness score will be high indicating that the troubleshooting path information is comprehensive and sufficient for generating accurate troubleshooting steps.

The work item creating subsystem 208 is further configured to extract at least one of: one or more contents of the one or more work items into a structured schema to identify one or more actions taken by at least one of: the one or more first users and the one or more second users, and questions and answers in the one or more work items, using the one or more language models. The structured schema is a structured representation that clearly identifies actions taken by the one or more first users who are work item filers and actions done by the one or more second users who are members of the support team, wherein this separation helps identify actions that can be safely executed by the work item filer and actions that require the support team to execute. The language models analyze the work item contents to extract questions and answers, wherein questions may be asked by the support team or the work item filer, and answers may be provided by the support team or the work item filer. Schema extraction can be computed with the help of a rule-based system, Machine Learning or Large Language Models (LLMs), which parse the unstructured text content of work items to identify and categorize different types of actions, questions, and answers into the structured schema format. For example, when a customer named Jake reports a server memory issue and the support engineer Mike responds with diagnostic questions and troubleshooting instructions, the language models extract the structured schema identifying that Jake performed actions such as “restarted the server” and “checked memory utilization”, Mike performed actions such as “analyzed logs” and “recommended configuration change”, Jake asked questions such as “What value should I set for num_replicas?”, Mike asked probing questions such as “When was the magenta cache server restarted?”, and the corresponding answers provided by both parties, thereby creating a clear structured representation of all interactions and actions within the work item.

The work item creating subsystem 208 is further configured to create ticket histories for the one or more work items to be stored as snapshots, using the one or more language models. For each snapshot, one or more signals are computed comprising at least one of: presence and absence of video calls, product information, diagnostics collected, completeness score, the one or more troubleshooting steps, actions by at least one of: the one or more first users and the one or more second users, the questions and answers, error codes, error messages, alert names, and alert messages.

The one or more language models are artificial intelligence models comprising at least one of: one or more Natural Language Processing (NLP) models, one or more Neural Networks (NNs), one or more Large Language Models (LLMs), one or more machine learning models, one or more rule-based models, and one or more reinforcement learning models, which are used to create ticket histories for the one or more work items to be stored as snapshots. The ticket histories capture the timeline for a work item as an accumulation of messages and metadata updates, wherein the work item evolves as a sequence such as (IT, Message1, Message2, Meta1, Message3, Meta2, Message4, . . . ), where IT denotes an initial work item with an initial message and metadata, {Message1, Message2, Message3, . . . } denote the one or more message updates, and {Meta1, Meta2, . . . } denote the one or more metadata field updates. The language models analyze each snapshot to compute a variety of signals comprising at least one of: presence and absence of video calls such as Zoom sessions, product information including product name, version number, and configuration, diagnostics collected during troubleshooting, completeness score measuring the completeness of troubleshooting path information, the one or more troubleshooting steps extracted from the work item, actions performed by at least one of the one or more first users who are work item filers and the one or more second users who are members of the support team, questions and answers exchanged between the parties, error codes and error messages reported in the work item, and alert names and alert messages associated with the issue. The language models also compute additional signals from the future of that snapshot, which refers to messages and metadata updates in the same work item that emerged after the snapshot boundary, including presence or absence of video calls in that future, troubleshooting steps, customer actions, support engineer actions, questions and answers in that future, error codes, error messages, alert names, and alert messages mentioned in that future. For example, when a customer named Jake reports a server memory issue and exchanges multiple messages with support engineer Mike, the language models create snapshots at each stage of the work item lifecycle such as (IT), (IT, Message1), (IT, Message1, Message2), and for each snapshot compute signals including presence of a Zoom call transcript, product information such as “magenta cache server version 2.1”, diagnostics collected such as “memory utilization at 95%”, completeness score of “High”, troubleshooting steps such as “Set the value of Gflag—num\_replicas to 3”, actions by Jake such as “restarted server” and actions by Mike such as “analyzed logs”, questions such as “When was the magenta cache server restarted?” and answers such as “Yesterday at 3 pm”, error code “MEM\_OVERFLOW\_001”, error message “Out of memory exception”, and alert name “Memory Critical Alert”.

The work item creating subsystem 208 is further configured to cluster and index the snapshots for retrieving the one or more work items, using one or more clustering techniques. The snapshots are clustered into one or more groups based on metrics comprising at least one of: semantic similarity between problem scenarios, semantic similarity between user configuration contexts, semantic similarity between the one or more troubleshooting steps, semantic similarity between the one or more actions by at least one of: the one or more first users and the one or more second users, semantic similarity between the questions and answers, and similarity of the product configuration. The snapshots are indexed using at least one of: probabilistic information retrieval ranking function and embeddings for retrieving the one or more snapshots based on the semantic similarity between the snapshots and the one or more work items.

The clustering and indexing is a process where all snapshots that have gone through the previous processing steps are organized for efficient retrieval, wherein the one or more clustering techniques comprise techniques like Hierarchical Agglomerative Clustering that group snapshots into overlapping or non-overlapping groups based on similarity metrics, wherein the semantic similarity between problem scenarios measures how closely related the issues described in different snapshots are, the semantic similarity between user configuration contexts measures how similar the customer environments and settings are across snapshots, the semantic similarity between the one or more troubleshooting steps measures how closely related the resolution actions are across snapshots, the semantic similarity between the one or more actions measures how similar the activities performed by the one or more first users who are work item filers and the one or more second users who are support team members are, the semantic similarity between the questions and answers measures how closely related the exchanges between parties are across snapshots, and the similarity of the product configuration measures how similar the product settings including product name, version number, and configuration are across snapshots. The snapshots are indexed using the probabilistic information retrieval ranking function such as BM25 and embeddings using software like Qdrant or Vespa or Elastic Search, wherein the indexes are used for retrieving snapshots based on semantic similarity between a snapshot and a work item, and the snapshots are also indexed by attributes including version numbers, product names, error codes, error messages, alert names, and alert messages to enable retrieval of snapshots relevant to a work item based on attribute similarity.

All knowledge base articles(sometimes called “KB Docs”), messages in ticketing/work item systems like Slack, and transcripts of video chats like Zoom calls are also clustered and indexed using techniques similar to those outlined above for snapshots. Both Clustering and Indexing help us identify the top snapshots and top documents (knowledge base articles, slack conversations, video chat transcripts) relevant to a work item.

In an aspect, for resolving the one or more work items based on the generated one or more troubleshooting responses, the troubleshooting response generating subsystem 212 is configured to compute the salutation by automatically deducing a name of the one or more first users by analyzing an initial work item from at least one of: subject, description, and metadata, using the one or more language models. The salutation is a greeting component of the work item update building blocks 304 that addresses the work item filer by name, such as “Hi Jake!” or a salutation in the context of the work item, for example, “Thanks, Jake, for filing a ticket for cluster failure.” The one or more language models automatically deduce the name of the one or more first users by inspecting the initial work item from at least one of: subject, description, and metadata, wherein the subject contains the title or summary of the issue, the description contains the detailed explanation of the problem provided by the work item filer, and the metadata contains filer data which may include a user, a group, a role account, a bot, and an automation, along with an identity of the work item filer. Such computation may be done with Large Language Models (LLMs) or other machine learning models that analyze the text content and metadata fields to extract the name of the work item filer for constructing a personalized greeting in the troubleshooting response.

The troubleshooting response generating subsystem 212 is further configured to generate a work item summary for establishing a shared context between an AI-based system and the one or more first users, using the one or more language models. The work item summary demonstrates that the AI-based system 102 has correctly understood an intent of the one or more work items. The work item summary is a succinct summary of the work item generated by the one or more language models that is helpful for grounding, which establishes a shared context or common understanding between the AI-based system 102 and the one or more first users who are work item filers. The work item summary demonstrates that the AI-based system 102 has correctly understood the intent of the one or more work items, and provides a context for the troubleshooting response which includes probing questions and troubleshooting steps as components. For example, when a customer named Jake reports a server memory issue, the work item summary generated by the language models may be “It looks like magenta cache server is running out of memory” which confirms to Jake that the system 102 has correctly identified and understood his reported problem before providing the troubleshooting steps.

The troubleshooting response generating subsystem 212 is further configured to retrieve past snapshots and documents relevant to the one or more work items from the clusters and indexes. The documents comprise at least one of: knowledge base articles, chat messages, and meeting transcripts. The past snapshots are ticket histories for the one or more work items stored as snapshots, wherein each snapshot captures the timeline for a work item as an accumulation of messages and metadata updates, and for each snapshot, one or more signals are computed comprising at least one of: presence and absence of video calls, product information, diagnostics collected, completeness score, the one or more troubleshooting steps, actions by the one or more first users and the one or more second users, questions and answers, error codes, error messages, alert names, and alert messages. The documents comprise at least one of: knowledge base articles which are support documents, product documents, installation guides, troubleshooting guides, and sales brochures that may be internal (visible only to the support team) or external (visible to both the work item filer and the support team), chat messages which are conversations in chat systems like Slack pertaining to the issue in the work item, and meeting transcripts which are transcripts of video calls such as Zoom calls pertaining to the issue in the work item.

The troubleshooting response generating subsystem 212 is further configured to extract the one or more troubleshooting steps and the one or more queries from a combination of the past snapshots and the documents. The troubleshooting steps and the one or more queries comprise at least one of: a verbatim copy of sentences from one or more sections of one or more knowledge base articles, a paraphrasing of the sentences, and content generated by the system 102. The one or more troubleshooting steps are steps employed for execution by at least one of: the members of the support team and the work item filer, such as “Set the value of Gflag—num\_replicas to 3”, and the one or more queries are probing questions directed at the work item filer to find the missing information that may assist in generating accurate one or more troubleshooting steps, such as “When was the magenta cache server restarted?”. The past snapshots are ticket histories for the one or more work items stored as snapshots capturing the timeline for a work item as an accumulation of messages and metadata updates, and the documents comprise at least one of: knowledge base articles, chat messages in ticketing systems like Slack, and transcripts of video chats like Zoom calls. The verbatim copy of sentences is an exact reproduction of sentences from one or more sections of one or more knowledge base articles without modification, the paraphrasing of the sentences is a rewording or rephrasing of the sentences from the knowledge base articles while preserving the original meaning, and the content generated by the system 102 is new content produced by the one or more language models based on the analysis of the past snapshots and documents that may intelligently combine the troubleshooting steps and probing questions derived from a suitable subset of sources including knowledge base documents, past work items and past snapshots, and conversations and meeting transcripts.

The Troubleshooting Steps come in two categories: TS for SE (i.e., steps meant for execution by members of support team/second users), and TS for ticket filers/first users (i.e., steps meant for execution by ticket filers). The probing questions (PQ) or queries are meant for ticket filers only, and not to compute PQ for Support Engineers (SE). The Troubleshooting Steps (TS) and Probing Questions (PQ) are computed as a 3-step process. Step 1: With the help of Clusters and Indexes (as described in the previous section, using software like Qdrant, BM25, Vespa, Elastic Search, and the like), the system 102 determines past snapshots and documents (knowledgebase articles, chat messages and meeting transcripts) that are relevant to the current ticket. Step 2: the system 102 extracts such steps from a combination of past snapshots and documents computed in Step 1, with the help of rule-based systems, Machine Learning and Large Language Models (LLMs).

Troubleshooting Steps and Probing Questions from KB documents: these are a verbatim copy of sentences from one or more sections of one or more knowledge base articles, or they may be a paraphrasing of such sentences, or they may be generated by Kahuna Platform (KP), or any combination of these.

Troubleshooting Steps and Probing Questions from Past Tickets and Past Snapshots: these steps and questions may be a verbatim copy of sentences from one or more sections of one or more past tickets, or they may be a paraphrasing of such sentences, or they may be generated by the system 102, or any combination of these. From past snapshots, troubleshooting steps and probing questions may be computed from the snapshot itself, or the “future of the snapshot” (messages and metadata updates in the ticket that lie in the future of that snapshot boundary).

Troubleshooting Steps and Probing Questions from Conversations in communication platforms like Slack, or Google Groups, or meeting transcripts(Zoom transcripts): Such steps and questions may be a verbatim copy of sentences from one or more sections of one or more such conversations, or they may be a paraphrasing of such sentences, or they may be generated by the system 102, or any combination of these.

Troubleshooting Steps and Probing Questions from a combination of the above sources: Troubleshooting steps and Probing Questions may also be generated by intelligently combining the troubleshooting steps and probing questions derived from a suitable subset of the sources listed above, namely from KB Documents, from Past Tickets and Past Snapshots, and from Conversations and Meeting Transcripts.

The system 102 handles special case scenarios like these as well: (a) sometimes, there are no troubleshooting steps or probing questions recommended for a ticket because the issue in that ticket has been resolved and/or the customer has confirmed that the issue has been resolved. In such cases, only metadata update is recommended (for example, a recommendation to change the status of the ticket from “Open” to “Resolved”); (b) Sometimes, instead of (or in addition to) generating troubleshooting steps and probing questions, the recommendation is to set up a meeting (via Zoom, for example) or to get a Remote Token to access the ticket filer's software systems for debugging and troubleshooting; and (c) Sometimes, specialized customer handling instructions are present; these are taken into account when computing troubleshooting steps (TS) and probing question (PQ).

Step 3: Confidence scores are computed for troubleshooting steps (TS) and probing questions (OQ). The confidence scores may be a numerical range, for example, between 0 and 1, or between 0% and 100%, or quantized into a small number of buckets, for example, {Low, Medium, High} or {High, Low}. The confidence scores are computed by combining completeness scores and credibility scores for tickets and snapshots (the current ticket and tickets corresponding to snapshots identified in Step 1 above), matching scores (scores that measure the strength of matches between the current ticket and snapshots and documents identified in Step 1 above), density scores (measures of overlap between the troubleshooting steps in all the relevant snapshots and documents identified in Step 1 above), and any other score helpful in computing confidence score. The strategy for combining such scores can be a rule-based system or Machine Learnt or even Large Language Model (LLM) based.

The Multi-Agent approach is configured to generate final recommendations. Multiple specialized agents collaborate to synthesize the results based on confidence scores of each agents.

The troubleshooting response generating subsystem 212 is further configured to compute metadata update recommendations from the relevant past snapshots and the documents by predicting updated values of the one or more metadata fields comprising the priority and severity levels, using the one or more language models. The system 102 recommends metadata updates, for example, to change the priority of a ticket from Priority Level 1 to Priority Level 2, or to change the severity of a case from “Severity Level 1” to “Severity Level 2”, or to escalate the ticket or to advance the ticket from “Tier 1” to “Tier 2”, or from “Frontline Support Engineers” to “Specialist Support Engineers”. The metadata update recommendations are computed as a 2-step process. Step 1 possesses relevant snapshots & documents: With the help of Clusters and Indexes (as described in the previous section, using software like Qdrant, BM25, Vespa, Elastic Search, and so on), the system 102 determines past snapshots and documents (knowledgebase articles, chat messages and meeting transcripts) that are relevant to the current ticket.

Step 2 possesses metadata update recommendations: from relevant snapshots and documents determined in Step 1, the system 102 predicts the updated value of metadata fields like Priority and Severity. For example, if the majority of relevant snapshots were assigned Priority 2, then the system 102 recommends that the priority of the current ticket should also be Priority 2. Such a computation may be done with a rule-based system or Machine Learnt system or with the help of Large Language Models (LLMs).

The troubleshooting response generating subsystem 212 is further configured to compute status change recommendations from the relevant past snapshots and the documents by predicting a value for the status information comprising at least one of: open, first user confirmation pending, waiting for the one or more first users to answer questions, and resolved, using the one or more language models. The system 102 recommends status changes as well, for example, to change the status of a ticket from “Open” to “Customer Confirmation Pending” or“Waiting for Customer to Answer our Questions” or “Resolved”. Step 1 possesses Relevant Snapshots & Documents: With the help of Clusters and Indexes (as described in the previous section, using software like Qdrant, BM25, Vespa, Elastic Search, and so on), the system 102 determines past snapshots and documents (knowledgebase articles, chat messages and meeting transcripts) that are relevant to the current ticket. Step 1 possesses status change recommendations: From relevant snapshots and documents determined in Step 1, along with the current ticket, the system 102 predicts the value for status. Such computation may be rule-based or machine learnt or derived from Large Language Models (LLMs).

The system 102 further generates a confidence score associated with status change recommendation. The confidence scores may be a numerical range, for example, between 0 and 1, or between 0% and 100%, or quantized into a small number of buckets, for example, {Low, Medium, High} or {High, Low}. The confidence scores are computed by combining completeness scores and credibility scores for tickets and snapshots (the current ticket and tickets corresponding to snapshots identified in Step 1 above), matching scores (scores that measure the strength of matches between the current ticket and snapshots and documents identified in Step 1 above), density scores (measures of overlap between the troubleshooting steps in all the relevant snapshots and documents identified in Step 1 above), and any other score helpful in computing confidence score. The strategy for combining such scores can be a rule-based system or Machine Learnt or even Large Language Model (LLM) based.

The troubleshooting response generating subsystem 212 is further configured to generate a closure comprising at least one of: instructions for escalation and instructions for reopening the one or more work items, using the one or more language models. The closure is a concluding component of the work item update building blocks 304 that provides final instructions and sign-off for the troubleshooting response, such as “Hope the troubleshooting steps outlined above resolve the one or more work items. Please do not hesitate to contact us if you need further assistance.—Mike (support engineer for x)”. The instructions for escalation are guidance provided to the one or more first users on how to escalate the one or more work items to higher-level support or specialized teams if the issue is not resolved by the provided troubleshooting steps. The instructions for reopening the one or more work items are guidance provided to the one or more first users on how to reopen the one or more work items if the issue persists or recurs after the one or more work items have been marked as resolved or closed. The closure is generated using the one or more language models comprising at least one of: one or more Natural Language Processing (NLP) models, one or more Neural Networks (NNs), one or more Large Language Models (LLMs), and one or more reinforcement learning models, using a combination of templates and LLMs to produce contextually appropriate concluding statements for the troubleshooting response.

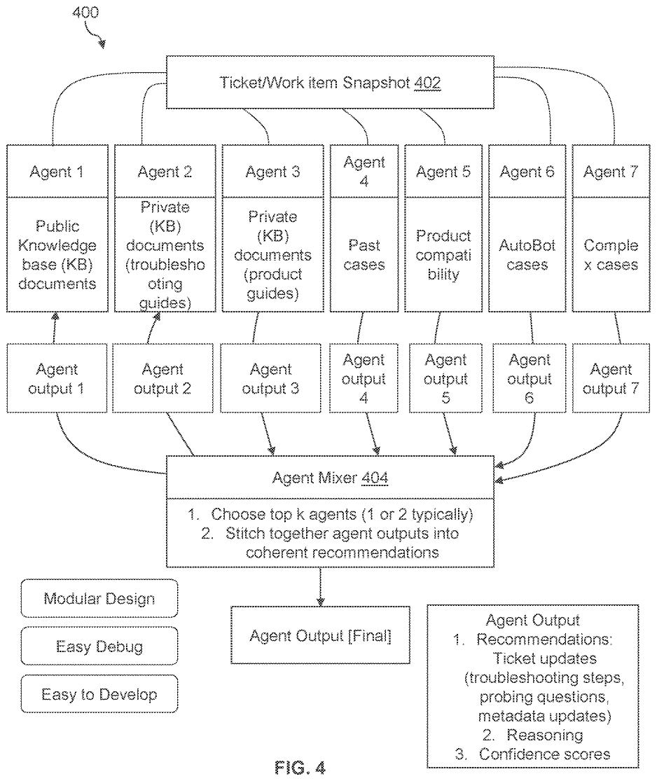

FIG. 4 illustrates a multi-agent architecture 400 with troubleshooting steps (TS) and probing questions (PQ) computation, in accordance with an embodiment of the present disclosure. The multi-agent architecture 400 is a sophisticated implementation, which is configured with the troubleshooting response generating subsystem 212 for computing troubleshooting steps (TS) and probing questions (PQ) wherein a collection of specialized agents work in parallel to process a ticket/work item snapshot 402, and each agent is designed to derive troubleshooting steps from a specific text corpus including Public KB Documents, Private KB Documents for troubleshooting guides, private KB documents for product guides, past cases, product compatibility information, AutoBot Cases, and complex cases. Each specialized agent produces/generates an agent output comprising three components: predictions which include troubleshooting steps, probing questions, and metadata updates. Reasoning which is an agent-specific textual description that explains why the troubleshooting steps merit high confidence. The confidence score which indicates how confident the agent is that their agent output contains the best troubleshooting steps and probing questions.

The Agent Mixer 404 is a central component that receives the agent outputs from all specialized agents, chooses the top k agents (typically 1 or 2) based on their confidence scores, and stitches together the agent outputs into coherent recommendations to produce the final agent output. The architecture is an ensemble of experts working in parallel with the Agent

Mixer 404 combining experts' recommendations into the final recommendation comprising output, reasoning, and signals. The ML/AI techniques for deriving the most accurate troubleshooting steps from the various text corpuses have their own unique requirements, thus specialized agents are designed for each text corpus separately, wherein some agents must necessarily use RAG (Retrieval→Ranking→Troubleshooting Steps Extraction→Response) pipeline, other agents may completely bypass RAG or use specialized variants of the RAG pipeline, and some agents may benefit from developing a Knowledge Graph (KG) and clustering on their text corpora while other agents may not need KG or clustering. The architecture provides benefits including modular design allowing independent development and maintenance of each agent, easy to debug enabling isolation of issues to specific agents, and easy to develop facilitating addition of new specialized agents for new text corpora without affecting existing agents.

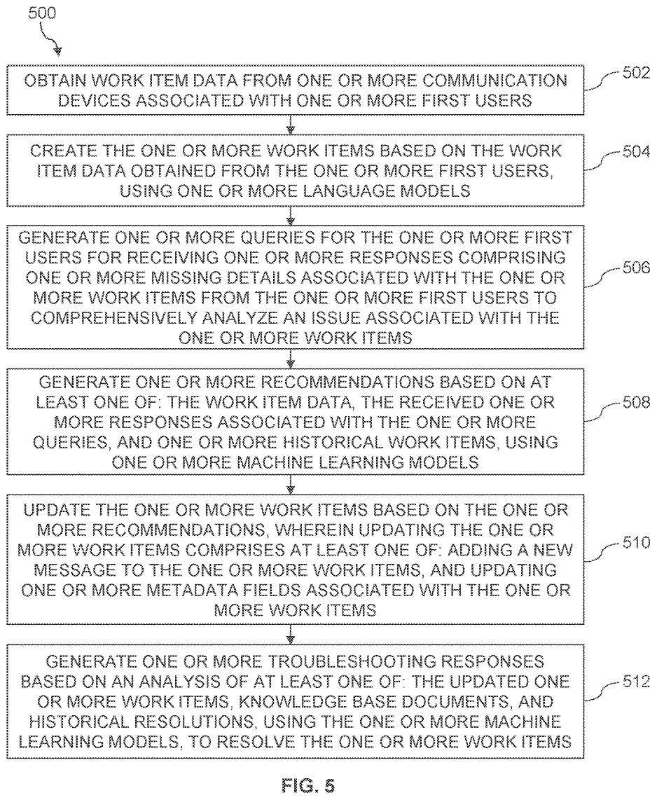

FIG. 5 is a flow chart illustrating an AI-based method 500 for resolving the one or more work items in the service management platforms, in accordance with an embodiment of the present disclosure.

At step 502, the work item data are obtained from the one or more communication devices 114 associated with the one or more first users.

At step 504, the one or more work items are created based on the work item data obtained from the one or more first users, using the one or more language models.

At step 506, the one or more queries are generated for the one or more first users for receiving one or more responses comprising the one or more missing details associated with the one or more work items from the one or more first users to comprehensively analyze the issue associated with the one or more work items.

At step 508, the one or more recommendations are generated based on at least one of: the work item data, the received one or more responses associated with the one or more queries, and one or more historical work items, using the one or more machine learning models. The one or more recommendations comprise at least one of: the one or more message updates and the one or more metadata field updates.

At step 510, the one or more work items are updated based on the one or more recommendations. Updating the one or more work items comprises at least one of: adding the new message to the one or more work items, and updating the one or more metadata fields associated with the one or more work items.

At step 512, the one or more troubleshooting responses are generated based on the analysis of at least one of: the updated one or more work items, the knowledge base documents, and the historical resolutions, using the one or more machine learning models. The one or more troubleshooting responses comprise at least one of: the one or more troubleshooting steps and the one or more queries for the one or more first users to determine the missing information that assist in generating accurate the one or more troubleshooting steps.

Numerous advantages of the present disclosure may be apparent from the discussion above. in accordance with the present disclosure, the system 102 for resolving the one or more work items in the service management platforms is disclosed. The system 102 automatically updates the one or more work items in the service management platforms, with minimal participation of the members of the support team. The system 102 is self-learning, leveraging historical work item data (one or more past work items) to generate insights even in the absence of formal documentation. The system 102 continuously adapts to a troubleshooting approach based on real-time one or more work item updates and evolving issue patterns. At every step of a work item journey, the system 102 provides one or more troubleshooting steps along with the probing questions to refine and expedite resolution. The system 102 is configured to reduce the time, effort, and skillset needed to troubleshoot the issues, especially in the context of complex technical products. The system 102 provides semi-automated and fully automated work item resolution for complex enterprise products.

The system 102 provides semi-automated and fully automated work item resolution for complex enterprise products, wherein in the semi-automatic updates, the support team may ingest, modify, and use the one or more recommendations to construct actual message updates and metadata field updates, and in the automatic updates, the system 102 may perform the message updates and metadata field updates directly without the approval of the support team members. The one or more reinforcement learning models continuously improve troubleshooting accuracy by learning from expert corrections and work item resolutions, enabling the system 102 to refine its recommendations and troubleshooting responses over time based on actual outcomes and expert feedback.

By ingesting all the data stored in the one or more databases 116, the system 102 synthesizes the knowledge graph 302, which aids the computation of work item update recommendations. At every step of a work item journey, the system 102 provides one or more troubleshooting steps along with the probing questions to refine and expedite resolution. By automating the formulation of the one or more troubleshooting responses using historical knowledge and AI-driven insights, the system 102 enhances efficiency, reduces response times, and maintains consistency across support interactions, ensuring that the one or more work items are addressed quickly, accurately, and with minimal user intervention, thereby improving overall service quality and user satisfaction.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the AI-based system 102 either directly or through intervening I/O controllers. Network adapters may also be coupled to the AI-based system 102 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/AI-based system 102 in accordance with the embodiments herein. The AI-based system 102 herein comprises at least one processor or central processing unit (CPU). The CPUs are interconnected via the system bus 202 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the AI-based system 102. The AI-based system 102 can read the inventive instructions on the program storage devices and follow these instructions to execute the methodology of the embodiments herein.

The AI-based system 102 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising”, “having”, “containing”, and “including”, and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a”, “an”, and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. An artificial intelligence (AI)-based method for resolving one or more work items in service management platforms, the AI-based method comprising:
obtaining, by one or more hardware processors, work item data from one or more communication devices associated with one or more first users;
creating, by the one or more hardware processors, the one or more work items based on the work item data obtained from the one or more first users, using one or more language models;
generating, by the one or more hardware processors, one or more queries for the one or more first users for receiving one or more responses comprising one or more missing details associated with the one or more work items from the one or more first users to comprehensively analyze an issue associated with the one or more work items;
generating, by the one or more hardware processors, one or more recommendations based on at least one of: the work item data, the received one or more responses associated with the one or more queries, and one or more historical work items, using one or more machine learning models, wherein the one or more recommendations comprise at least one of: one or more message updates and one or more metadata field updates;
updating, by the one or more hardware processors, the one or more work items based on the one or more recommendations, wherein updating the one or more work items comprises at least one of: adding a new message to the one or more work items, and updating one or more metadata fields associated with the one or more work items; and
generating, by the one or more hardware processors, one or more troubleshooting responses based on an analysis of at least one of: the updated one or more work items, knowledge base documents, and historical resolutions, using the one or more machine learning models, to resolve the one or more work items, wherein the one or more troubleshooting responses comprise at least one of: one or more troubleshooting steps and the one or more queries for the one or more first users to determine missing information that assist in generating accurate one or more troubleshooting steps.

2. The AI-based method of claim 1, wherein creating the one or more work items based on the work item data, using the one or more language models, comprises:
recognizing, by the one or more hardware processors, one or more work item descriptions from the work item data obtained from the one or more first users through at least one of: manual entry, an electronic mail, a text communication, an audio communication, a video communication, and an application programming interface, using the one or more language models;
extracting, by the one or more hardware processors, relevant data from the work item data based on the recognized one or more work item descriptions; and
creating, by the one or more hardware processors, the one or more work items being structured based on the extracted relevant data, wherein the structured one or more work items include at least one of: subject and description fields, along with the one or more metadata fields,
wherein the subject and description fields comprise product information comprising at least one of: product name, version number, and configuration, optional documents comprising at least one of: Portable Document Formats (PDFs), screenshots, audio transcripts, spreadsheets, data dumps, files, images, and equivalent forms of digital content, and
wherein the one or more metadata fields comprise creation time of the one or more work items, an identity of the one or more first users and associated environment, status information of the one or more work items, and priority and severity levels of the one or more work items.

3. The AI-based method of claim 1, upon creating the one or more work items, further comprising processing the one or more work items, by:
augmenting, by the one or more hardware processors, the one or more work items with one or more attributes comprising at least one of: transcripts of video calls pertaining to an issue in the one or more work items, conversations in chat systems pertaining to the issue in the one or more work items, one or more documents related to the one or more work items, and one or more relevant work items;
augmenting, by the one or more hardware processors, the one or more work items with one or more additional attributes to record contextual metadata related to at least one of: product version, product configuration, user information, deployment environment related information, source configuration data, user relationship management systems, and product backend;
masking, by the one or more hardware processors, sensitive information including personally identifiable information by at least one of: substituting the sensitive information with one or more generic identifiers and redacting the sensitive information;
removing, by the one or more hardware processors, noisy and repetitive information from the one or more work items, using the one or more language models, wherein the noisy and repetitive information comprise at least one of: signatures in the electronic mail, parts of the electronic mail that quote previous electronic mails in an electronic mail thread, and electronic mails with operational steps;
computing, by the one or more hardware processors, a credibility score of the one or more work items, using at least one of: the one or more language models, one or more machine learning models, and one or more rule-based models, wherein the credibility score is a measure of trustworthiness of contents of the one or more work items derived from one or more signals comprising at least one of: first user confirmation indicating whether the issue was resolved, and frequency of references to at least one of: the knowledge base documents and the one or more troubleshooting steps across work items similar to the one or more work items, and wherein the one or more signals are at least one of: each independent signal and a combination of the two or more signals;
computing, by the one or more hardware processors, a completeness score of the one or more work items, using at least one of: the one or more language models, one or more machine learning models, and one or more rule-based models, wherein the completeness score is a measure of completeness of troubleshooting path information available in the one or more work items derived from the one or more signals comprising at least one of: absence and presence of transcripts of video chats, absence and presence of descriptions of actual steps carried out by at least one of: the one or more first users and one or more second users, absence and presence of links to related work items and relevant knowledge base documents, and absence and presence of attachments comprising at least one of: logs, screenshots, errors, and stacktraces;
extracting, by the one or more hardware processors, at least one of: one or more contents of the one or more work items into a structured schema to identify one or more actions taken by at least one of: the one or more first users and the one or more second users, and questions and answers in the one or more work items, using the one or more language models;
creating, by the one or more hardware processors, ticket histories for the one or more work items to be stored as snapshots, using the one or more language models, wherein for each snapshot, one or more signals are computed comprising at least one of: presence and absence of video calls, product information, diagnostics collected, completeness score, the one or more troubleshooting steps, actions by at least one of: the one or more first users and the one or more second users, the questions and answers, error codes, error messages, alert names, and alert messages; and
clustering and indexing, by the one or more hardware processors, the snapshots for retrieving the one or more work items, using one or more clustering techniques, wherein the snapshots are clustered into one or more groups based on metrics comprising at least one of: semantic similarity between problem scenarios, semantic similarity between user configuration contexts, semantic similarity between the one or more troubleshooting steps, semantic similarity between the one or more actions by at least one of: the one or more first users and the one or more second users, semantic similarity between the questions and answers, and similarity of the product configuration, and wherein the snapshots are indexed using at least one of: probabilistic information retrieval ranking function and embeddings for retrieving the one or more snapshots based on the semantic similarity between the snapshots and the one or more work items.

4. The AI-based method of claim 1, wherein resolving the one or more work items based on the generated one or more troubleshooting responses, comprises:
computing, by the one or more hardware processors, a salutation by automatically deducing a name of the one or more first users by analyzing an initial work item from at least one of: subject, description, and metadata, using the one or more language models;
generating, by the one or more hardware processors, a work item summary for establishing a shared context between an AI-based system and the one or more first users, using the one or more language models, wherein the work item summary demonstrates that the AI-based system has correctly understood an intent of the one or more work items;
retrieving, by the one or more hardware processors, past snapshots and documents relevant to the one or more work items from the clusters and indexes, wherein the documents comprise at least one of: knowledge base articles, chat messages, and meeting transcripts;
extracting, by the one or more hardware processors, the one or more troubleshooting steps and the one or more queries from a combination of the past snapshots and the documents, wherein the troubleshooting steps and the one or more queries comprise at least one of: a verbatim copy of sentences from one or more sections of one or more knowledge base articles, a paraphrasing of the sentences, and content generated by the system;
computing, by the one or more hardware processors, metadata update recommendations from the relevant past snapshots and the documents by predicting updated values of the one or more metadata fields comprising the priority and severity levels, using the one or more language models;
computing, by the one or more hardware processors, status change recommendations from the relevant past snapshots and the documents by predicting a value for the status information comprising at least one of: open, first user confirmation pending, waiting for the one or more first users to answer questions, and resolved, using the one or more language models;
computing, by the one or more hardware processors, confidence scores for the troubleshooting steps and the one or more queries by combining at least one of:
completeness scores, credibility scores, matching scores measuring strength of matches between the one or more work items and the past snapshots and the documents, and density scores measuring overlap between the troubleshooting steps in the relevant past snapshots and the documents, using the one or more language models; and
generating, by the one or more hardware processors, a closure comprising at least one of: instructions for escalation and instructions for reopening the one or more work items, using the one or more language models.

5. The AI-based method of claim 1, wherein generating the one or more troubleshooting responses, using the one or more machine learning models, comprises:
extracting, by the one or more hardware processors, one or more features comprising at least one of: issue descriptors, contextual parameters, and metadata, from the updated one or more work items;
retrieving, by the one or more hardware processors, the one or more historical work items and corresponding resolution data from one or more knowledge sources based on the extracted one or more features;
generating, by the one or more hardware processors, one or more similarity representations between the updated one or more work items and the one or more historical work items, using the one or more neural networks;
identifying, by the one or more hardware processors, one or more relevant historical work items and associated resolution patterns based on the one or more similarity representations;
determining, by the one or more hardware processors, one or more relationships between the updated one or more work items, the one or more historical work items, and the corresponding resolution data, using the one or more neural networks; and
generating, by the one or more hardware processors, the one or more troubleshooting steps for the one or more first users, based on the determined one or more relationships.

6. The AI-based method of claim 1, further comprising utilizing, by the one or more hardware processors, a knowledge graph for generating the one or more troubleshooting responses, by:
synthesizing, by the one or more hardware processors, the knowledge graph based on the work item data stored in one or more knowledge sources, wherein the knowledge graph is a graph structure with nodes and edges, wherein the nodes indicate one or more semantic concepts comprising at least one of: the one or more work items, one or more historical work items, the one or more troubleshooting steps, the knowledge base documents comprising internal and external knowledge base documents, and the one or more queries, and wherein the edges indicate one or more relationships between the nodes;
mapping, by the one or more hardware processors, one or more elements of the work item data to corresponding nodes in the knowledge graph;
traversing, by the one or more hardware processors, the knowledge graph to identify one or more related nodes corresponding to one or more relevant historical work items and associated resolution data;
extracting, by the one or more hardware processors, the one or more troubleshooting steps associated with the identified nodes based on the traversed knowledge graph; and
generating, by the one or more hardware processors, the one or more troubleshooting responses based on the extracted one or more troubleshooting steps.

7. The AI-based method of claim 1, further comprising at least one of:
maintaining, by the one or more hardware processors, the one or more work items as open until the one or more first users confirm a status of the issue associated with the one or more work items;
upon resolution of the one or more work items, updating, by the one or more hardware processors, the status of the one or more metadata fields to a pre-defined value comprising at least one of: closed and resolved, to indicate completion of a work item lifecycle, wherein the status update prevents application of subsequent message updates and metadata field updates to the one or more work items; and
continuing, by the one or more hardware processors, the status update of the one or more work items with further exchanges between the one or more first users and at least one of: the one or more second users and the AI-based system, when the issue associated with the one or more work items persists.

8. The AI-based method of claim 1, further comprising continuously optimizing, by the one or more hardware processors, troubleshooting accuracy by learning from expert corrections and work item resolutions, using one or more reinforcement learning models.

9. The AI-based method of claim 1, wherein generating the one or more troubleshooting responses comprises utilizing a multi-agent architecture, by:
processing, by the one or more hardware processors, each snapshot associated with the one or more work items through a plurality of agents working in parallel, wherein each agent is configured to derive the one or more troubleshooting steps from a text corpus comprising at least one of: public knowledge base documents, private knowledge base documents for troubleshooting guides, private knowledge base documents for product guides, past cases, and product compatibility information;
generating, by the one or more hardware processors, an agent output by each agent, comprising: one or more predictions that comprise at least one of: the one or more troubleshooting steps, the one or more queries, and the one or more metadata field updates, reasoning that comprise an agent-specific textual description explaining why the one or more troubleshooting steps merit high confidence, and one or more confidence scores indicating how confident the agent is that the agent output contains the best one or more troubleshooting steps and the one or more queries;
receiving, by the one or more hardware processors, the agent outputs from the plurality of agents, using an agent mixer;
selecting, by the one or more hardware processors, top k agents based on the confidence scores associated with the agent outputs, using the agent mixer; and
combining, by the one or more hardware processors, the agent outputs from the selected top k agents into one or more coherent recommendations to generate a final agent output comprising the one or more troubleshooting responses, using the agent mixer.

10. An artificial intelligence (AI)-based system for resolving one or more work items in service management platforms, the AI-based system comprising:
one or more hardware processors; and
a memory coupled to the one or more hardware processors, wherein the memory comprises a plurality of subsystems in form of programmable instructions executable by the one or more hardware processors, and wherein the plurality of subsystems comprises:
a data obtaining subsystem configured to obtain work item data from one or more communication devices associated with one or more first users;
a work item creating subsystem configured to:
create the one or more work items based on the work item data obtained from the one or more first users, using one or more language models; and
generate one or more queries for the one or more first users for receiving one or more responses comprising one or more missing details associated with the one or more work items from the one or more first users to comprehensively analyze an issue associated with the one or more work items;
a recommendations generating subsystem configured to:
generate one or more recommendations based on at least one of:
the work item data and the received one or more responses associated with the one or more queries, using one or more machine learning models, wherein the one or more recommendations comprise at least one of: one or more message updates and one or more metadata field updates; and
update the one or more work items based on the one or more recommendations, wherein updating the one or more work items comprises at least one of: adding a new message to the one or more work items, and updating one or more metadata fields associated with the one or more work items; and
a troubleshooting response generating subsystem configured to generate one or more troubleshooting responses based on an analysis of at least one of: the updated one or more work items, knowledge base documents, and historical resolutions, using the one or more machine learning models, to resolve the one or more work items, wherein the one or more troubleshooting responses comprise at least one of: one or more troubleshooting steps and the one or more queries for the one or more first users to determine missing information that assist in generating accurate one or more troubleshooting steps.

11. The AI-based system of claim 10, wherein in creating the one or more work items based on the work item data, using the one or more language models, the work item creating subsystem is further configured to:
recognize one or more work item descriptions from the work item data obtained from the one or more first users through at least one of: manual entry, an electronic mail, a text communication, an audio communication, a video communication, and an application programming interface, using the one or more language models;
extract relevant data from the work item data based on the recognized one or more work item descriptions; and
create the one or more work items being structured based on the extracted relevant data, wherein the structured one or more work items include at least one of:
subject and description fields, along with the one or more metadata fields, wherein the subject and description fields comprise product information comprising at least one of: product name, version number, and configuration, optional documents comprising at least one of: Portable Document Formats (PDFs), screenshots, audio transcripts, spreadsheets, data dumps, files, images, and equivalent forms of digital content, and
wherein the one or more metadata fields comprise creation time of the one or more work items, an identity of the one or more first users and associated environment, status information of the one or more work items, and priority and severity levels of the one or more work items.

12. The AI-based system of claim 10, upon creating the one or more work items, the work item creating subsystem is further configured to process the one or more work items, by:
augmenting the one or more work items with one or more attributes comprising at least one of: transcripts of video calls pertaining to an issue in the one or more work items, conversations in chat systems pertaining to the issue in the one or more work items, one or more documents related to the one or more work items, and one or more relevant work items;
augmenting the one or more work items with one or more additional attributes to record contextual metadata related to at least one of: product version, product configuration, user information, deployment environment related information, source configuration data, user relationship management systems, and product backend;
masking sensitive information including personally identifiable information by at least one of: substituting the sensitive information with one or more generic identifiers and redacting the sensitive information;
removing noisy and repetitive information from the one or more work items, using the one or more language models, wherein the noisy and repetitive information comprise at least one of: signatures in the electronic mail, parts of the electronic mail that quote previous electronic mails in an electronic mail thread, and electronic mails with operational steps;
computing a credibility score of the one or more work items, using at least one of:
the one or more language models, one or more machine learning models, and one or more rule-based models, wherein the credibility score is a measure of trustworthiness of contents of the one or more work items derived from one or more signals comprising at least one of: first user confirmation indicating whether the issue was resolved, and frequency of references to at least one of: the knowledge base documents and the one or more troubleshooting steps across work items similar to the one or more work items, and wherein the one or more signals are at least one of: each independent signal and a combination of the two or more signals;
computing a completeness score of the one or more work items, using at least one of: the one or more language models, one or more machine learning models, and one or more rule-based models, wherein the completeness score is a measure of completeness of troubleshooting path information available in the one or more work items derived from the one or more signals comprising at least one of: absence and presence of transcripts of video chats, absence and presence of descriptions of actual steps carried out by at least one of: the one or more first users and one or more second users, absence and presence of links to related work items and relevant knowledge base documents, and absence and presence of attachments comprising at least one of: logs, screenshots, errors, and stacktraces;
extracting at least one of: one or more contents of the one or more work items into a structured schema to identify one or more actions taken by at least one of: the one or more first users and the one or more second users, and questions and answers in the one or more work items, using the one or more language models;
creating ticket histories for the one or more work items to be stored as snapshots, using the one or more language models, wherein for each snapshot, one or more signals are computed comprising at least one of: presence and absence of video calls, product information, diagnostics collected, completeness score, the one or more troubleshooting steps, actions by at least one of: the one or more first users and the one or more second users, the questions and answers, error codes, error messages, alert names, and alert messages; and
clustering and indexing the snapshots for retrieving the one or more work items, using one or more clustering techniques, wherein the snapshots are clustered into one or more groups based on metrics comprising at least one of: semantic similarity between problem scenarios, semantic similarity between user configuration contexts, semantic similarity between the one or more troubleshooting steps, semantic similarity between the one or more actions by at least one of: the one or more first users and the one or more second users, semantic similarity between the questions and answers, and similarity of the product configuration, and wherein the snapshots are indexed using at least one of:
probabilistic information retrieval ranking function and embeddings for retrieving the one or more snapshots based on the semantic similarity between the snapshots and the one or more work items.

13. The AI-based system of claim 10, wherein in resolving the one or more work items based on the generated one or more troubleshooting responses, the troubleshooting response generating subsystem is further configured to:
compute a salutation by automatically deducing a name of the one or more first users by analyzing an initial work item from at least one of: subject, description, and metadata, using the one or more language models;
generate a work item summary for establishing a shared context between an AI-based system and the one or more first users, using the one or more language models, wherein the work item summary demonstrates that the AI-based system has correctly understood an intent of the one or more work items;
retrieve past snapshots and documents relevant to the one or more work items from the clusters and indexes, wherein the documents comprise at least one of: knowledge base articles, chat messages, and meeting transcripts;
extract the one or more troubleshooting steps and the one or more queries from a combination of the past snapshots and the documents, wherein the troubleshooting steps and the one or more queries comprise at least one of: a verbatim copy of sentences from one or more sections of one or more knowledge base articles, a paraphrasing of the sentences, and content generated by the system;
compute metadata update recommendations from the relevant past snapshots and the documents by predicting updated values of the one or more metadata fields comprising the priority and severity levels, using the one or more language models; compute status change recommendations from the relevant past snapshots and the documents by predicting a value for the status information comprising at least one of: open, first user confirmation pending, waiting for the one or more first users to answer questions, and resolved, using the one or more language models;
compute confidence scores for the troubleshooting steps and the one or more queries by combining at least one of: completeness scores, credibility scores, matching scores measuring strength of matches between the one or more work items and the past snapshots and the documents, and density scores measuring overlap between the troubleshooting steps in the relevant past snapshots and the documents, using the one or more language models; and
generate a closure comprising at least one of: instructions for escalation and instructions for reopening the one or more work items, using the one or more language models.

14. The AI-based system of claim 10, wherein in generating the one or more troubleshooting responses, using the one or more machine learning models, the troubleshooting response generating subsystem is further configured to:
extract one or more features comprising at least one of: issue descriptors, contextual parameters, and metadata, from the updated one or more work items;
retrieve the one or more historical work items and corresponding resolution data from one or more knowledge sources based on the extracted one or more features;
generate one or more similarity representations between the updated one or more work items and the one or more historical work items, using the one or more neural networks;
identify one or more relevant historical work items and associated resolution patterns based on the one or more similarity representations;
determine one or more relationships between the updated one or more work items, the one or more historical work items, and the corresponding resolution data, using the one or more neural networks; and
generate the one or more troubleshooting steps for the one or more first users, based on the determined one or more relationships.

15. The AI-based system of claim 10, wherein the troubleshooting response generating subsystem is further configured to utilize a knowledge graph for generating the one or more troubleshooting responses, by:
synthesizing the knowledge graph based on the work item data stored in one or more knowledge sources, wherein the knowledge graph is a graph structure with nodes and edges, wherein the nodes indicate one or more semantic concepts comprising at least one of: the one or more work items, one or more historical work items, the one or more troubleshooting steps, the knowledge base documents comprising internal and external knowledge base documents, and the one or more queries, and wherein the edges indicate one or more relationships between the nodes;
mapping one or more elements of the work item data to corresponding nodes in the knowledge graph;
traversing the knowledge graph to identify one or more related nodes corresponding to one or more relevant historical work items and associated resolution data;
extracting the one or more troubleshooting steps associated with the identified nodes based on the traversed knowledge graph; and
generating the one or more troubleshooting responses based on the extracted one or more troubleshooting steps.

16. The AI-based system of claim 10, wherein the troubleshooting response generating subsystem is further configured to at least one of:
maintain the one or more work items as open until the one or more first users confirm a status of the issue associated with the one or more work items;
upon resolution of the one or more work items, update the status of the one or more metadata fields to a pre-defined value comprising at least one of: closed and resolved, to indicate completion of a work item lifecycle, wherein the status update prevents application of subsequent message updates and metadata field updates to the one or more work items; and
continue the status update of the one or more work items with further exchanges between the one or more first users and at least one of: the one or more second users and the AI-based system, when the issue associated with the one or more work items persists.

17. The AI-based system of claim 10, wherein the troubleshooting response generating subsystem is further configured to continuously optimize troubleshooting accuracy by learning from expert corrections and work item resolutions, using one or more reinforcement leaning models.

18. The AI-based system of claim 10, wherein in generating the one or more troubleshooting responses comprises utilizing a multi-agent architecture, the troubleshooting response generating subsystem is further configured to:
process each snapshot associated with the one or more work items through a plurality of agents working in parallel, wherein each agent is configured to derive the one or more troubleshooting steps from a text corpus comprising at least one of: public knowledge base documents, private knowledge base documents for troubleshooting guides, private knowledge base documents for product guides, past cases, and product compatibility information;
generate an agent output by each agent, comprising: one or more predictions that comprise at least one of: the one or more troubleshooting steps, the one or more queries, and the one or more metadata field updates, reasoning that comprise an agent-specific textual description explaining why the one or more troubleshooting steps merit high confidence, and one or more confidence scores indicating how confident the agent is that the agent output contains the best one or more troubleshooting steps and the one or more queries;
receive the agent outputs from the plurality of agents, using an agent mixer;
select top k agents based on the confidence scores associated with the agent outputs, using the agent mixer; and
combine the agent outputs from the selected top k agents into one or more coherent recommendations to generate a final agent output comprising the one or more troubleshooting responses, using the agent mixer.

19. A non-transitory computer-readable storage medium having instructions stored therein that when executed by one or more hardware processors, cause the one or more hardware processors to execute operations of:
obtaining work item data from one or more communication devices associated with one or more first users;
creating one or more work items based on the work item data obtained from the one or more first users, using one or more language models;
generating one or more queries for the one or more first users for receiving one or more responses comprising one or more missing details associated with the one or more work items from the one or more first users to comprehensively analyze an issue associated with the one or more work items;
generating one or more recommendations based on at least one of: the work item data, the received one or more responses associated with the one or more queries, and one or more historical work items, using one or more machine learning models, wherein the one or more recommendations comprise at least one of: one or more message updates and one or more metadata field updates;
updating the one or more work items based on the one or more recommendations, wherein updating the one or more work items comprises at least one of: adding a new message to the one or more work items, and updating one or more metadata fields associated with the one or more work items; and
generating one or more troubleshooting responses based on an analysis of at least one of: the updated one or more work items, knowledge base documents, and historical resolutions, using the one or more machine learning models, to resolve the one or more work items, wherein the one or more troubleshooting responses comprise at least one of:
one or more troubleshooting steps and the one or more queries for the one or more first users to determine missing information that assist in generating accurate one or more troubleshooting steps.

20. The non-transitory computer-readable storage medium of claim 18, wherein creating the one or more work items based on the work item data, using the one or more language models, comprises:
recognizing one or more work item descriptions from the work item data obtained from the one or more first users through at least one of: manual entry, an electronic mail, a text communication, an audio communication, a video communication, and an application programming interface, using the one or more language models;
extracting relevant data from the work item data based on the recognized one or more work item descriptions; and
creating the one or more work items being structured based on the extracted relevant data, wherein the structured one or more work items include at least one of: subject and description fields, along with the one or more metadata fields,
wherein the subject and description fields comprise product information comprising at least one of: product name, version number, and configuration, optional documents comprising at least one of: Portable Document Formats (PDFs), screenshots, audio transcripts, spreadsheets, data dumps, files, images, and equivalent forms of digital content, and
wherein the one or more metadata fields comprise creation time of the one or more work items, an identity of the one or more first users and associated environment, status information of the one or more work items, and priority and severity levels of the one or more work items.
